(19) United States
(12) Patent Application Publication
(10) Pub. No.: US 2024/0280829 A1
(43) Pub. Date: Aug. 22, 2024

(54) OPTICAL ELEMENT AND IMAGE DISPLAY APPARATUS

(71) Applicant: FUJIFILM Corporation, Tokyo (JP)

(72) Inventors: Masaaki SUZUKI, Minamiashigara-shi (JP); Hiroshi SATO, Minamiashigara-shi (JP)

(73) Assignee: FUJIFILM Corporation, Tokyo (JP)

(21) Appl. No.: 18/648,554

(22) Filed: Apr. 29, 2024

Related U.S. Application Data
(63) Continuation of application No. PCT/JP2022/042084, filed on Nov. 11, 2022.

(30) Foreign Application Priority Data
Nov. 12, 2021 (JP) 2021-184669

(51) Int. Cl. G02B 27/42; G02B 5/30

(52) U.S. Cl. CPC G02B 27/4205; G02B 5/3016

(57) ABSTRACT

Provided are an optical element having a high diffraction efficiency of transmitted light and an image display apparatus formed of the optical element. The optical element includes at least: a first optically-anisotropic layer that is formed of a liquid crystal composition including a liquid crystal compound; and a second optically-anisotropic layer that is formed of a liquid crystal composition including a liquid crystal compound, in which the first optically-anisotropic layer and the second optically-anisotropic layer have a liquid crystal alignment pattern in which an orientation of an optical axis derived from the liquid crystal compound changes while continuously rotating in at least one in-plane direction, a birefringence Δn1 of the first optically-anisotropic layer and a birefringence Δn2 of the second optically-anisotropic layer satisfy a relationship of Expression (1), a thickness T1 of the first optically-anisotropic layer and a thickness T2 of the second optically-anisotropic layer satisfy a relationship of Expression (2), and transmitted light is diffracted.

$$Δ n 1 > Δ n 2 \qquad Expression ( 1 )$$

$$0.002 \leq T 2 / T 1 \leq 0.3 \qquad Expression ( 2 )$$

### CROSS-REFERENCE TO RELATED APPLICATIONS

This application is a Continuation of PCT International Application No. PCT/JP2022/042084 filed on Nov. 11, 2022, which claims priority under 35 U.S.C. § 119(a) to Japanese Patent Application No. 2021-184669 filed on Nov. 12, 2021. The above applications are hereby expressly incorporated by reference, in their entirety, into the present application.

### BACKGROUND OF THE INVENTION

### 1. Field of the Invention

The present invention relates to an optical element and an image display apparatus.

### 2. Description of the Related Art

An optical element (diffraction element) that controls a direction of light is used in many optical devices or systems. For example, the optical element that controls a direction of light is used in various optical devices, for example, a backlight of a liquid crystal display device, a head mounted display (HMD) such as Augmented Reality (AR) glasses or virtual reality (VR) that display a virtual image, various information, or the like to be superimposed on a scene that is actually being seen, a projector, a beam steering device, or a sensor for detecting a thing or measuring the distance to a thing.

In this optical device, a reduction in thickness and size has progressed. Therefore, a reduction in thickness and size is desired for the optical element used in the optical device. As the thin and small optical element, the use of an optically-anisotropic layer consisting of a liquid crystal composition including a liquid crystal compound is disclosed.

For example, JP2008-532085A describes a polarization diffraction grating including a polarization sensitive photoalignment layer and a liquid crystal composition arranged on the photoalignment layer, in which an anisotropic alignment pattern corresponding to a polarization hologram is arranged in the photoalignment layer, and the liquid crystal composition is aligned in the alignment pattern. The alignment pattern in the polarization diffraction grating periodically changes along at least one straight line in a plane, and by using the optically-anisotropic layer that changes this alignment pattern in the plane, an optical element that is thin and controls a transmission direction of incident light can be realized.

### SUMMARY OF THE INVENTION

According to an investigation by the present inventors, the optical element that changes the liquid crystal alignment pattern in the plane to diffract light has a problem in that, in a case where the diffraction angle increases, the diffraction efficiency decreases, that is, the intensity of diffracted light decreases.

An object of the present invention is to solve the above-described problem of the related art and to provide an optical element having a high diffraction efficiency of transmitted light and an image display apparatus formed of the optical element.

In order to achieve the object, the present invention has the following configurations.

[1] An optical element comprising at least:
a first optically-anisotropic layer that is formed of a liquid crystal composition including a liquid crystal compound; and
a second optically-anisotropic layer that is formed of a liquid crystal composition including a liquid crystal compound,
in which the first optically-anisotropic layer and the second optically-anisotropic layer have a liquid crystal alignment pattern in which an orientation of an optical axis derived from the liquid crystal compound changes while continuously rotating in at least one in-plane direction,
a birefringence Δn1 of the first optically-anisotropic layer and a birefringence Δn2 of the second optically-anisotropic layer satisfy a relationship of Expression (1), a thickness T1 of the first optically-anisotropic layer and a thickness T2 of the second optically-anisotropic layer satisfy a relationship of Expression (2), and transmitted light is diffracted,

$$Δ n 1 > Δ n 2 , and \qquad Expression ( 1 )$$

$$0.002 \leq T 2 / T 1 \leq 0.3 . \qquad Expression ( 2 )$$

[2] The optical element according to [1],
in which the birefringence Δn1 is 0.21 or more and 0.50 or less, and
the birefringence Δn2 is 0.05 or more and 0.20 or less.

[3] The optical element according to [1] or [2], further comprising:
a third optically-anisotropic layer that is formed of a liquid crystal composition including a liquid crystal compound,
in which the third optically-anisotropic layer has a liquid crystal alignment pattern in which an orientation of an optical axis derived from the liquid crystal compound changes while continuously rotating in at least one in-plane direction,
the second optically-anisotropic layer, the first optically-anisotropic layer, and the third optically-anisotropic layer are laminated in this order,
a birefringence Δn3 of the third optically-anisotropic layer and the birefringence Δn1 satisfy a relationship of Expression (3), and
a thickness T3 of the third optically-anisotropic layer and the thickness T1 satisfy a relationship of Expression (4),

$$Δ n 1 > Δ n 3 , and \qquad Expression ( 3 )$$

$$0.002 \leq T 3 / T 1 \leq 0.3 . \qquad Expression ( 4 )$$

[4] The optical element according to [3],
in which the birefringence Δn3 is 0.05 or more and 0.20 or less.

[5] The optical element according to [3] or [4],
in which the birefringence Δn1, the birefringence Δn2, and the birefringence Δn3 satisfy relationships of Expressions (5) and (6),

$$0.1 \leq Δ n 1 - Δ n 2 \leq 0.25 , and \qquad Expression ( 5 )$$

$$0.1 \leq Δ n 1 - Δ n 3 \leq 0.25 . \qquad Expression ( 6 )$$

[6] The optical element according to any one of [1] to [5],
in which the thickness T1 is 1 μm to 3 μm.

[7] The optical element according to any one of [1] to [6],
in which the liquid crystal compound is a tolane type liquid crystal compound.

[8] The optical element according to any one of [1] to [7],
in which the liquid crystal compound is a thiotolane type liquid crystal compound.

[9] The optical element according to any one of [1] to [8],
in which the first optically-anisotropic layer has a region where the optical axis of the liquid crystal compound is twisted along a thickness direction in a plane, and
a twisted angle of the region in the thickness direction is 10° to 360°.

[10] The optical element according to any one of [3] to [9],
in which in the liquid crystal alignment pattern of the first to third optically-anisotropic layers, the one direction in which the orientation of the optical axis derived from the liquid crystal compound changes while continuously rotating is provided in a radial shape from an inner side toward an outer side.

[11] An image display apparatus comprising:
the optical element according to any one of [1] to [10].

[12] The image display apparatus according to [11], which is a head mounted display.

According to the present invention, it is possible to provide an optical element having a high diffraction efficiency of transmitted light and an image display apparatus formed of the optical element.

### BRIEF DESCRIPTION OF THE DRAWINGS

FIG. 1 is a schematic diagram showing an example of an optical element according to the present invention.

FIG. 2 is a partially enlarged view conceptually showing a configuration of the optical element shown in FIG. 1.

FIG. 3 is a plan view showing the optical element shown in FIG. 2.

FIG. 4 is a diagram showing an action of the optical element.

FIG. 5 is a diagram showing the action of the optical element.

FIG. 6 is a schematic diagram showing another example of the optical element according to the present invention.

FIG. 7 is a conceptual diagram showing another example of an optically-anisotropic layer in the optical element according to the present invention.

FIG. 8 is a diagram showing an example of an exposure device that forms an alignment pattern.

FIG. 9 is a plan view conceptually showing another example of the optical element according to the present invention.

FIG. 10 is a diagram showing another example of the exposure device that forms the alignment pattern.

FIG. 11 is a diagram showing a method of measuring an intensity of light in Examples.

FIG. 12 is a diagram showing the method of measuring an intensity of light in Examples.

FIG. 13 is a conceptual diagram showing another example of the optically-anisotropic layer in the optical element according to the present invention.

### DESCRIPTION OF THE PREFERRED EMBODIMENTS

Hereinafter, the details of the present invention will be described. In the present specification, numerical ranges represented by “to” include numerical values before and after “to” as lower limit values and upper limit values.

In addition, in the present specification, “(meth)acrylate” represents both of acrylate and methacrylate, “(meth)acryloyl group” represents both of an acryloyl group and a methacryloyl group, and “(meth)acryl” represents both of acryl and methacryl.

In the present invention, visible light refers to light having a wavelength which can be observed by human eyes among electromagnetic waves and refers to light in a wavelength range of 380 to 780 nm. Ultraviolet light is a light in a wavelength range of 10 nm or longer and shorter than 380 nm, and infrared light is a light in a wavelength range of longer than 780 nm.

In addition, in visible light, light in a wavelength range of 420 to 490 nm refers to blue light (B), light in a wavelength range of 495 to 570 nm refers to green light (G), and light in a wavelength range of 620 to 750 nm refers to red light (R).

### [Optical Element]

An optical element according to an embodiment of the present invention comprises at least:
a first optically-anisotropic layer that is formed of a liquid crystal composition including a liquid crystal compound; and
a second optically-anisotropic layer that is formed of a liquid crystal composition including a liquid crystal compound,
in which the first optically-anisotropic layer and the second optically-anisotropic layer have a liquid crystal alignment pattern in which an orientation of an optical axis derived from the liquid crystal compound changes while continuously rotating in at least one in-plane direction,
a birefringence Δn1 of the first optically-anisotropic layer and a birefringence Δn2 of the second optically-anisotropic layer satisfy a relationship of Expression (1),
a thickness T1 of the first optically-anisotropic layer and a thickness T2 of the second optically-anisotropic layer satisfy a relationship of Expression (2), and
transmitted light is diffracted.

$$Δ n 1 > Δ n 2 \qquad Expression ( 1 )$$

$$0.002 \leq T 2 / T 1 \leq 0.3 \qquad Expression ( 2 )$$

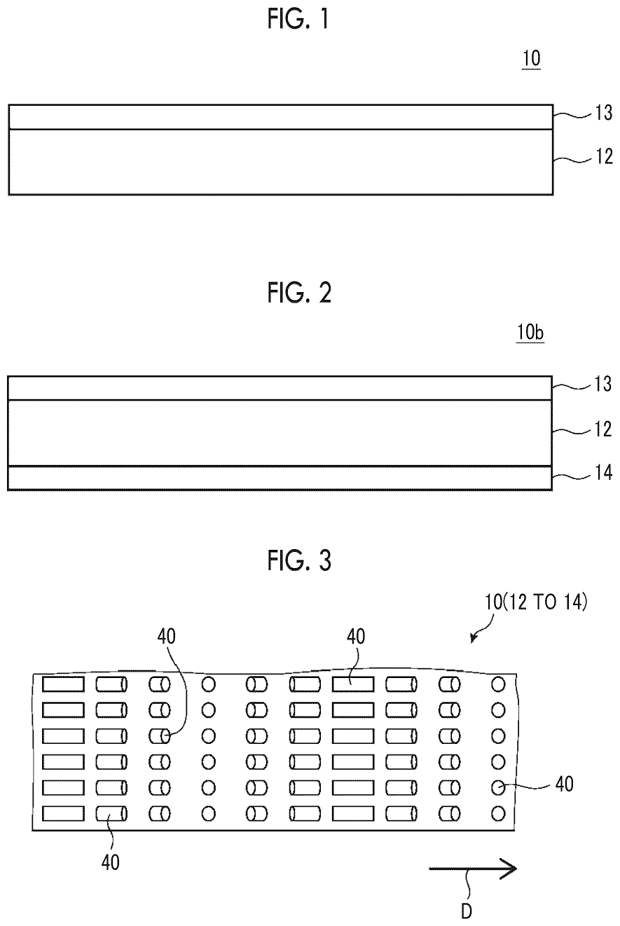

FIG. 1 is a diagram conceptually showing an example of the optical element according to the embodiment of the present invention.

An optical element 10 shown in FIG. 1 includes a first optically-anisotropic layer 12 and a second optically-anisotropic layer 13.

The first optically-anisotropic layer 12 and the second optically-anisotropic layer 13 are optically-anisotropic layers that are formed of a liquid crystal composition including a cholesteric liquid crystal compound. In addition, as shown in FIGS. 2 and 3 below, the first optically-anisotropic layer and the second optically-anisotropic layer have a liquid crystal alignment pattern in which an orientation of an optical axis derived from the liquid crystal compound continuously rotates in one in-plane direction. Although described below, the optically-anisotropic layer having the liquid crystal alignment pattern in which the orientation of the optical axis derived from the liquid crystal compound continuously rotates in the one in-plane direction functions as a diffraction element that diffracts transmitted light. That is, the optical element according to the embodiment of the present invention functions as the diffraction element that diffracts transmitted light.

Here, in the optical element according to the embodiment of the present invention, a birefringence Δn1 of the first optically-anisotropic layer 12 and a birefringence Δn2 of the second optically-anisotropic layer 13 satisfy a relationship of Expression (1).

$$Δ n 1 > Δ n 2 \qquad Expression ( 1 )$$

In addition, a thickness T1 of the first optically-anisotropic layer and a thickness T2 of the second optically-anisotropic layer satisfy a relationship of Expression (2).

$$0.002 \leq T 2 / T 1 \leq 0.3 \qquad Expression ( 2 )$$

That is, the optical element according to the embodiment of the present invention includes: the first optically-anisotropic layer 12 having the high birefringence Δn1; and the second optically-anisotropic layer 13 having the low birefringence Δn2, in which the thickness of the first optically-anisotropic layer 12 having the high birefringence Δn1 is more than the thickness of the second optically-anisotropic layer 13 having the low birefringence Δn2.

As described above, the optical element (optically-anisotropic layer) that changes the liquid crystal alignment pattern in the plane to diffract light has a problem in that, in a case where the diffraction angle increases, the diffraction efficiency decreases, that is, the intensity of diffracted light decreases.

From the viewpoint of the diffraction efficiency, it is advantageous that the birefringence (difference in refractive index) Δn of the optically-anisotropic layer is high. However, as the birefringence Δn increases, a change in birefringence Δn at an interface between the optically-anisotropic layer and the outside increases, and the amount of light reflected from the interface increases. As a result, it is found that the transmittance of light decreases, and the diffraction efficiency decreases.

On the other hand, in the optical element according to the embodiment of the present invention, by providing the first optically-anisotropic layer having the high birefringence Δn1 and the second optically-anisotropic layer having the low birefringence Δn2, the reflection of light incident from the second optically-anisotropic layer having the low birefringence Δn2 from the interface can be suppressed. In addition, by diffracting the light from the first optically-anisotropic layer having the high birefringence Δn1 with high diffraction efficiency, a decrease in transmittance of the light as the optical element can be suppressed, and the diffraction efficiency of transmitted light can be improved. In this case, by setting the thickness of the first optically-anisotropic layer 12 to be more than that of the second optically-anisotropic layer 13, contribution to the diffraction efficiency of the first optically-anisotropic layer 12 increases. Therefore, by utilizing the high diffraction efficiency of the first optically-anisotropic layer 12, the diffraction efficiency as the optical element can be improved.

Here, in the example shown in FIG. 1, the optical element 10 is configured to include the first optically-anisotropic layer 12 and the second optically-anisotropic layer 13. However, the present invention is not limited to this configuration, and the optical element according to the embodiment of the present invention may be configured to further include a third optically-anisotropic layer 14 as in an optical element 10b shown in FIG. 2.

The optical element 10b shown in FIG. 2 includes the second optically-anisotropic layer 13, the first optically-anisotropic layer 12, and the third optically-anisotropic layer 14 in this order.

The third optically-anisotropic layer 14 is formed of a liquid crystal composition including a liquid crystal compound, and has a liquid crystal alignment pattern in which an orientation of an optical axis derived from the liquid crystal compound changes while continuously rotating in at least one in-plane direction.

In the configuration including the third optically-anisotropic layer 14, the birefringence Δn1 of the first optically-anisotropic layer 12 and a birefringence Δn3 of the third optically-anisotropic layer 14 satisfy a relationship of Expression (3) below.

$$Δ n 1 > Δ n 3 \qquad Expression ( 3 )$$

In addition, the thickness T1 of the first optically-anisotropic layer and a thickness T3 of the third optically-anisotropic layer satisfy a relationship of Expression (4) below.

$$0.002 \leq T 3 / T 1 \leq 0.3 \qquad Expression ( 4 )$$

That is, the optical element 10b includes the first optically-anisotropic layer 12 having the high birefringence Δn1, the second optically-anisotropic layer 13 having the low birefringence Δn2, and the third optically-anisotropic layer 14 having the low birefringence Δn3, in which the thickness of the first optically-anisotropic layer 12 having the high birefringence Δn1 is more than the thicknesses of the second optically-anisotropic layer 13 having the low birefringence Δn2 and the third optically-anisotropic layer 14 having the low birefringence Δn3. That is, the optical element 10b has the configuration in which the thick first optically-anisotropic layer 12 having the high birefringence Δn1 is interposed between the thin optically-anisotropic layers having the low birefringence Δn in a thickness direction.

This way, even in the configuration where the third optically-anisotropic layer 14 is provided on the surface of the first optically-anisotropic layer 12 opposite to the side where the second optically-anisotropic layer 13 is disposed, the reflection of light incident from the second optically-anisotropic layer side having the low birefringence Δn2 or light incident from the third optically-anisotropic layer side having the low birefringence Δn3 from the interface is suppressed. In addition, by diffracting the light from the first optically-anisotropic layer having the high birefringence Δn1 with high diffraction efficiency, a decrease in transmittance of the light as the optical element can be suppressed, and the diffraction efficiency of transmitted light can be improved. In this case, by setting the thickness of the first optically-anisotropic layer 12 to be more than those of the second optically-anisotropic layer 13 and the third optically-anisotropic layer 14, contribution to the diffraction efficiency of the first optically-anisotropic layer 12 increases. Therefore, by utilizing the high diffraction efficiency of the first optically-anisotropic layer 12, the diffraction efficiency as the optical element can be improved.

The configurations of the second optically-anisotropic layer 13 and the third optically-anisotropic layer 14 such as the birefringence Δn and the thickness T may be the same as or different from each other.

Here, from the viewpoint of diffraction efficiency, the birefringence Δn1 of the first optically-anisotropic layer 12 is preferably 0.21 or more and 0.50 or less, more preferably 0.30 or more and 0.45 or less, and still more preferably 0.35 or more and 0.40 or less.

In addition, from the viewpoint of suppressing the reflection from the interface, the birefringence Δn2 of the second optically-anisotropic layer 13 is preferably 0.05 or more and 0.20 or less, more preferably 0.08 or more and 0.17 or less, and still more preferably 0.10 or more and 0.15 or less. Likewise, the birefringence Δn3 of the third optically-anisotropic layer 14 is preferably 0.05 or more and 0.20 or less, more preferably 0.08 or more and 0.17 or less, and still more preferably 0.10 or more and 0.15 or less.

In addition, from the viewpoints of obtaining the diffraction efficiency and suppressing the reflection from the interface, it is preferable that the birefringence Δn1 of the first optically-anisotropic layer 12, the birefringence Δn2 of the second optically-anisotropic layer 13, and the birefringence Δn3 of the third optically-anisotropic layer 14 satisfy relationships of Expressions (5) and (6) below.

$$0.1 \leq Δ n 1 - Δ n 2 \leq 0.25 \qquad Expression ( 5 )$$

$$0.1 \leq Δ n 1 - Δ n 3 \leq 0.25 \qquad Expression ( 6 )$$

A difference (Δn1−Δn2) between the birefringence Δn1 of the first optically-anisotropic layer 12 and the birefringence Δn2 of the second optically-anisotropic layer 13 is more preferably 0.12 to 0.23 and still more preferably 0.15 to 0.20. Likewise, a difference (Δn1−Δn3) between the birefringence Δn1 of the first optically-anisotropic layer 12 and the birefringence Δn3 of the third optically-anisotropic layer 14 is more preferably 0.12 to 0.23 and still more preferably 0.15 to 0.20.

In addition, from the viewpoints of obtaining the diffraction efficiency and suppressing the reflection from the interface, the ratio (T2/T1) between the thickness T1 of the first optically-anisotropic layer and the thickness T2 of the second optically-anisotropic layer is preferably 0.01 to 0.1 and more preferably 0.02 to 0.05. Likewise, the ratio (T3/T1) between the thickness T1 of the first optically-anisotropic layer and the thickness T3 of the third optically-anisotropic layer is preferably 0.01 to 0.1 and more preferably 0.02 to 0.05.

In addition, from the viewpoint of the diffraction efficiency, the thickness T1 of the first optically-anisotropic layer 12 is preferably 1 μm to 3 μm, more preferably 1.5 μm to 2.7 μm, and still more preferably 2.0 μm to 2.5 μm.

In addition, from the viewpoints of obtaining the diffraction efficiency and suppressing the reflection from the interface, the thickness T2 of the second optically-anisotropic layer 13 is preferably 0.02 μm to 1.0 μm, more preferably 0.03 μm to 0.5 μm, and still more preferably 0.05 μm to 0.1 μm. Likewise, the thickness T3 of the third optically-anisotropic layer 14 is preferably 0.02 μm to 1.0 μm, more preferably 0.03 μm to 0.5 μm, and still more preferably 0.05 m to 0.1 μm.

<<Method of Measuring Δn>>

In the present specification, Δn (Δn1, Δn2, Δn3) can be measured as follows.

The liquid crystal composition forming each of the layers is separately applied to an alignment film having uniaxial aligning properties, is uniaxially aligned, and is cured. Next, Δn×d is obtained by a birefringence measuring device. Further, by measuring the thickness d of a cross section with a cross-section cutting method, an interference film thickness meter, and the like, Δn can be calculated. As a result, Δn1, Δn2, Δn3, T1, T2, and T3 can be obtained.

Hereinafter, the optically-anisotropic layer will be described in detail. In the following description, in a case where the first to third optically-anisotropic layers do not need to be distinguished from each other, the first to third optically-anisotropic layers will be collectively referred to as the optically-anisotropic layer.

### <Optically-Anisotropic Layer>

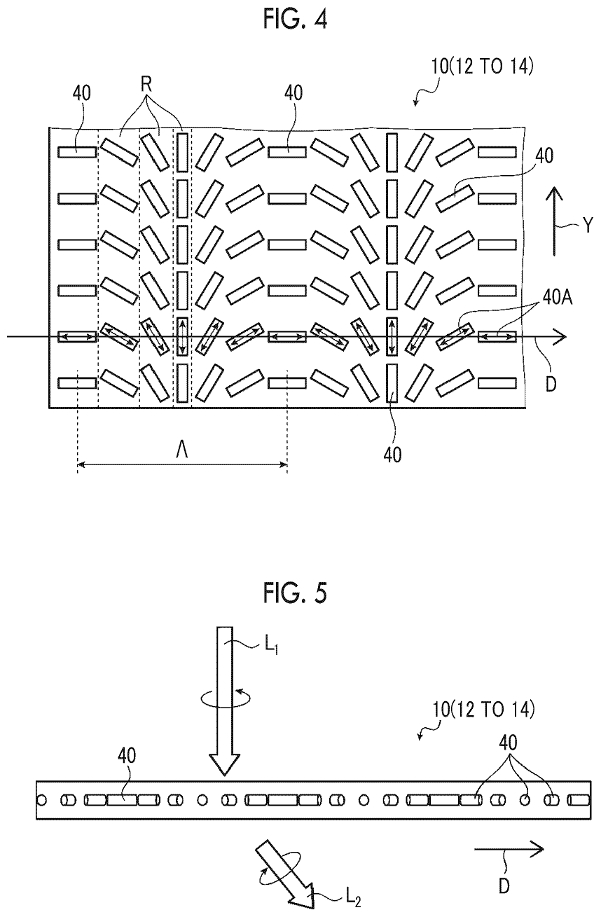

The optically-anisotropic layer will be described using FIGS. 3 and 4.

In the example shown in FIGS. 3 and 4, the optically-anisotropic layer is formed by immobilizing a liquid crystal phase where a liquid crystal compound is aligned and has a liquid crystal alignment pattern in which an orientation of an optical axis derived from the liquid crystal compound changes while continuously rotating in at least one in-plane direction.

In the optically-anisotropic layer, as conceptually shown in FIG. 3, a liquid crystal compound 40 is not helically twisted and rotated in the thickness direction, and the liquid crystal compounds 40 at the same position in a plane direction are aligned such that the orientations of optical axes 40A thereof are directed in the same orientation.

### <<Liquid Crystal Alignment Pattern of Optically-Anisotropic Layer>>

The optically-anisotropic layer has the liquid crystal alignment pattern in which the orientation of the optical axis 40A derived from the liquid crystal compound 40 changes while continuously rotating in the one direction in a plane of the optically-anisotropic layer.

The optical axis 40A derived from the liquid crystal compound 40 is an axis having the highest refractive index in the liquid crystal compound 40, that is, a so-called slow axis. For example, in a case where the liquid crystal compound 40 is a rod-like liquid crystal compound, the optical axis 40A is parallel to a rod-like major axis direction. In the following description, the optical axis 40A derived from the liquid crystal compound 40 will also be referred to as “the optical axis 40A of the liquid crystal compound 40” or “the optical axis 40A”.

FIG. 4 conceptually shows a plan view of the optically-anisotropic layer.

The plan view is a view in a case where the optically-anisotropic layer is seen from the top in FIG. 3, that is, a view in a case where the optically-anisotropic layer is seen from a thickness direction (laminating direction of the respective layers (films)).

In addition, in FIG. 4, in order to clarify the configuration of the optically-anisotropic layer, only the liquid crystal compound 40 on the surface is shown.

As shown in FIG. 4, on the surface, the liquid crystal compound 40 forming the optically-anisotropic layer has the liquid crystal alignment pattern in which the orientation of the optical axis 40A changes while continuously rotating in a predetermined one direction indicated by arrow D (hereinafter, referred to as the arrangement axis D) in a plane of the optically-anisotropic layer. In the example shown in the drawing, the liquid crystal compound 40 has the liquid crystal alignment pattern in which the optical axis 40A of the liquid crystal compound 40 changes while continuously rotating clockwise in the arrangement axis D direction.

The liquid crystal compound 40 forming the optically-anisotropic layer is two-dimensionally arranged in a direction orthogonal to the arrangement axis D and the one direction (arrangement axis D direction).

In the following description, the direction orthogonal to the arrangement axis D direction will be referred to as “Y direction” for convenience of description. That is, the arrow Y direction is a direction orthogonal to the one direction in which the orientation of the optical axis 40A of the liquid crystal compound 40 changes while continuously rotating in the optically-anisotropic layer. Accordingly, in FIGS. 1 to 3 and FIGS. 5 to 7 described below, the Y direction is a direction orthogonal to the paper plane.

Specifically, “the orientation of the optical axis 40A of the liquid crystal compound 40 changes while continuously rotating in the arrangement axis D direction (the predetermined one direction)” represents that an angle between the optical axis 40A of the liquid crystal compound 40, which is arranged in the arrangement axis D direction, and the arrangement axis D direction varies depending on positions in the arrangement axis D direction, and the angle between the optical axis 40A and the arrangement axis D direction sequentially changes from θ to θ+180° or θ−180° in the arrangement axis D direction.

A difference between the angles of the optical axes 40A of the liquid crystal compounds 40 adjacent to each other in the arrangement axis D direction is preferably 45° or less, more preferably 15° or less, and still more preferably less than 15°.

In addition, in the present invention, the liquid crystal compound rotates in the orientation in which an angle between the optical axes 40A of the liquid crystal compounds 40 adjacent to each other in the arrangement axis D direction decreases. Accordingly, in the optically-anisotropic layer shown in FIGS. 3 and 4, the optical axis 40A of the liquid crystal compound 40 rotates to the right (clockwise) in the direction indicated by the arrow of the arrangement axis D.

On the other hand, in the liquid crystal compound 40 forming the optically-anisotropic layer, the orientations of the optical axes 40A are the same in the Y direction orthogonal to the arrangement axis D direction, that is, the Y direction orthogonal to the one direction in which the optical axis 40A continuously rotates.

In other words, in the liquid crystal compound 40 forming the optically-anisotropic layer, angles between the optical axes 40A of the liquid crystal compound 40 and the arrangement axis D direction are the same in the Y direction.

In the liquid crystal compounds arranged in the Y direction in the optically-anisotropic layer, the angles between the optical axes 40A and the arrangement axis D direction (the one direction in which the orientation of the optical axis of the liquid crystal compound 40 rotates) are the same. Regions where the liquid crystal compounds 40 in which the angles between the optical axes 40A and the arrangement axis D direction are the same are disposed in the Y direction will be referred to as “regions R”.

In this case, it is preferable that an in-plane retardation (Re) value of each of the regions R is a half wavelength, that is, λ/2. The in-plane retardation is calculated from the product of a difference Δn in refractive index generated by refractive index anisotropy of the region R and the thickness of the optically-anisotropic layer. Here, the difference in refractive index generated by refractive index anisotropy of the region R in the optically-anisotropic layer is defined by a difference between a refractive index of a direction of an in-plane slow axis of the region R and a refractive index of a direction orthogonal to the direction of the slow axis. That is, the difference Δn in refractive index generated by refractive index anisotropy of the region R is the same as a difference between a refractive index of the liquid crystal compound 40 in the direction of the optical axis 40A and a refractive index of the liquid crystal compound 40 in a direction perpendicular to the optical axis 40A in a plane of the region R. That is, the difference Δn in refractive index is the same as the difference in refractive index of the liquid crystal compound 40.

In the optically-anisotropic layer, in the liquid crystal alignment pattern of the liquid crystal compound 40, the length (distance) over which the optical axis 40A of the liquid crystal compound 40 rotates by 180° in the arrangement axis D direction in which the optical axis 40A changes while continuously rotating in a plane is the length Λ of the single period in the liquid crystal alignment pattern.

That is, a distance between centers of two liquid crystal compounds 40 in the arrangement axis D direction is the length Λ of the single period, the two liquid crystal compounds having the same angle in the arrangement axis D direction. Specifically, as shown in FIG. 4, a distance between centers in the arrangement axis D direction of two liquid crystal compounds 40 in which the arrangement axis D direction and the direction of the optical axis 40A match each other is the length Λ of the single period. In the following description, the length Λ of the single period will also be referred to as “single period λ”.

In the liquid crystal alignment pattern of the optically-anisotropic layer, the single period A is repeated in the arrangement axis D direction, that is, in the one direction in which the orientation of the optical axis 40A changes while continuously rotating.

In a case where circularly polarized light is incident into the above-described optically-anisotropic layer, the light is refracted such that the direction of the circularly polarized light is converted.

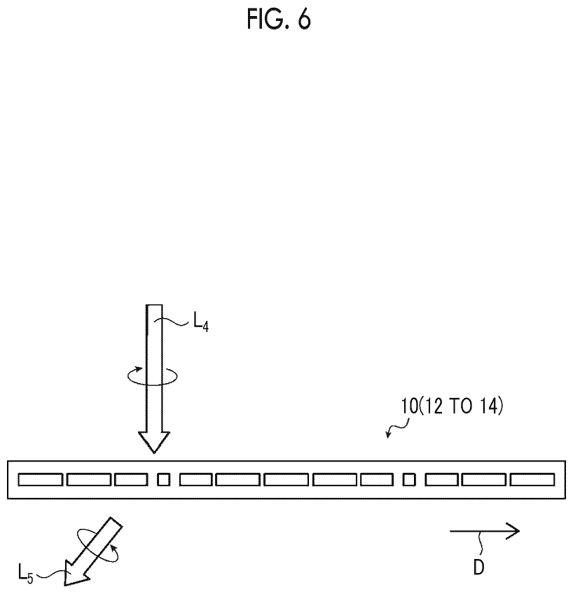

This action is conceptually shown in FIGS. 5 and 6. In the optically-anisotropic layer, the value of the product of the difference in refractive index of the liquid crystal compound and the thickness of the optically-anisotropic layer is λ/2.

As shown in FIG. 5, in a case where the value of the product of the difference in refractive index of the liquid crystal compound and the thickness of the optically-anisotropic layer in the optically-anisotropic layer is λ/2 and incidence light L₁ as left circularly polarized light is incident into the optically-anisotropic layer, the incidence light L₁ transmits through the optically-anisotropic layer to be imparted with a retardation of 180°, and the transmitted light L₂ is converted into right circularly polarized light.

In addition, the liquid crystal alignment pattern formed in the optically-anisotropic layer is a pattern that is periodic in the arrangement axis D direction. Therefore, the transmitted light L₂ travels in a direction different from a traveling direction of the incidence light L₁. This way, the incidence light L₁ of the left circularly polarized light is converted into the transmitted light L₂ of right circularly polarized light that is tilted by a predetermined angle in the arrangement axis D direction with respect to an incidence direction. In the example shown in FIG. 5, the transmitted light L₂ is diffracted to travel in the lower right direction.

On the other hand, as shown in FIG. 6, in a case where the value of the product of the difference in refractive index of the liquid crystal compound and the thickness of the optically-anisotropic layer in the optically-anisotropic layer is λ/2 and incidence light L₄ as right circularly polarized light is incident into the optically-anisotropic layer, the incidence light L₄ transmits through the optically-anisotropic layer to be imparted with a retardation of 180° and is converted into transmitted light L₅ of left circularly polarized light.

In addition, the liquid crystal alignment pattern formed in the optically-anisotropic layer is a pattern that is periodic in the arrangement axis D direction. Therefore, the transmitted light L₅ travels in a direction different from a traveling direction of the incidence light L₄. In this case, the transmitted Light L₅ travels in a direction different from the transmitted light L₂, that is, in a direction opposite to the arrow direction of the arrangement axis D with respect to the incidence direction. This way, the incidence light L₄ is converted into the transmitted light L₅ of left circularly polarized light that is tilted by a predetermined angle in a direction opposite to the arrangement axis D direction with respect to an incidence direction. In the example shown in FIG. 6, the transmitted light L₅ is diffracted to travel in the lower left direction.

Here, refraction angles of the transmitted light components L₂ and L₅ can be adjusted depending on the length of the single period Λ of the liquid crystal alignment pattern formed in the optically-anisotropic layer. Specifically, even in the optically-anisotropic layer, as the single period Λ of the liquid crystal alignment pattern decreases, light components transmitted through the liquid crystal compounds 40 adjacent to each other more strongly interfere with each other. Therefore, the transmitted light components L₂ and L₅ can be more largely refracted.

In addition, by reversing the rotation direction of the optical axis 40A of the liquid crystal compound 40 that rotates in the arrangement axis D direction, the refraction direction of transmitted light can be reversed. That is, in the example FIGS. 5 and 6, the rotation direction of the optical axis 40A toward the arrangement axis D direction is clockwise. By setting this rotation direction to be counterclockwise, the refraction direction of transmitted light can be reversed. Specifically, in FIGS. 5 and 6, in a case where the rotation direction of the optical axis 40A toward the arrangement axis D direction is counterclockwise, left circularly polarized light incident into the optically-anisotropic layer from the upper side in the drawing transmits through the optically-anisotropic layer such that the transmitted light is converted into right circularly polarized light and is diffracted to travel in the lower left direction in the drawing. In addition, right circularly polarized light incident into the optically-anisotropic layer from the upper side in the drawing transmits through the optically-anisotropic layer such that the transmitted light is converted into left circularly polarized light and is diffracted to travel in the lower right direction in the drawing.

In the optical element according to the embodiment of the present invention, the first optically-anisotropic layer, the second optically-anisotropic layer, and the third optically-anisotropic layer have the same liquid crystal alignment pattern, and the optical axes of the liquid crystal compounds 40 present at the same position in the plane direction face the same direction.

### <<Method of Forming Optically-Anisotropic Layer>>

An optically-anisotropic layer can be formed by applying a liquid crystal composition including a liquid crystal compound to an alignment film for aligning the liquid crystal compound in a predetermined liquid crystal alignment pattern to form a liquid crystal phase that is aligned in the liquid crystal alignment pattern in which an orientation of an optical axis derived from the liquid crystal compound changes while continuously rotating in at least one in-plane direction, and immobilizing the liquid crystal phase in a layer shape.

### (Support)

As a support that supports the alignment film and the optically-anisotropic layer, various sheet-shaped materials (films or plate-shaped materials) can be used as long as they can support the alignment film and the optically-anisotropic layer.

A transmittance of the support with respect to light to be diffracted is preferably 50% or more, more preferably 70% or more, and still more preferably 85% or more.

The thickness of the support is not particularly limited and may be appropriately set depending on the use of the optical element, a material for forming the support, and the like in a range where the alignment film and the optically-anisotropic layer can be supported.

The thickness of the support is preferably in a range of 1 to 1000 μm, more preferably in a range of 3 to 250 μm, and still more preferably in a range of 5 to 150 μm.

The support may have a monolayer structure or a multi-layer structure.

In a case where the support has a monolayer structure, examples thereof include supports formed of glass, triacetyl cellulose (TAC), polyethylene terephthalate (PET), polycarbonates, polyvinyl chloride, acryl, polyolefin, and the like. In a case where the support has a multi-layer structure, examples thereof include a support including: one of the above-described supports having a monolayer structure that is provided as a substrate; and another layer that is provided on a surface of the substrate.

### (Alignment Film)

The alignment film is formed on the surface of the support.

The alignment film is an alignment film for aligning the liquid crystal compound 40 to the predetermined liquid crystal alignment pattern during the formation of the optically-anisotropic layer.

As described above, in the present invention, the optically-anisotropic layer has the liquid crystal alignment pattern in which the orientation of the optical axis 40A (refer to FIG. 4) derived from the liquid crystal compound 40 changes while continuously rotating in one in-plane direction. Accordingly, the alignment film is formed such that the optically-anisotropic layer can form the liquid crystal alignment pattern.

In the following description, “the orientation of the optical axis 40A rotates” will also be simply referred to as “the optical axis 40A rotates”.

As the alignment film, various well-known films can be used.

Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as ω-tricosanoic acid, dioctadecylmethylammonium chloride, or methyl stearate.

The alignment film formed by a rubbing treatment can be formed by rubbing a surface of a polymer layer with paper or fabric in a given direction multiple times.

As the material used for the alignment film, a material for forming polyimide, polyvinyl alcohol, a polymer having a polymerizable group described in JP1997-152509A (JP-H9-152509A), or an alignment film 32 and the like described in JP2005-97377A, JP2005-99228A, and JP2005-128503A is preferable.

The alignment film can be suitably used as a so-called photo-alignment film obtained by irradiating a photo-alignment material with polarized light or non-polarized light. That is, a photo-alignment film that is formed by applying a photo-alignment material to the support is suitably used as the alignment film.

The irradiation of polarized light can be performed in a direction perpendicular or oblique to the photo-alignment film, and the irradiation of non-polarized light can be performed in a direction oblique to the photo-alignment film.

Preferable examples of the photo-alignment material used in the alignment film that can be used in the present invention include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking polyester, a cinnamate compound, or a chalcone compound is suitably used.

A thickness of the alignment film is not particularly limited. The thickness with which a required alignment function can be obtained may be appropriately set depending on the material for forming the alignment film.

The thickness of the alignment film is preferably 0.01 to 5 μm and more preferably 0.05 to 2 μm.

A method of forming the alignment film is not limited. Any one of various well-known methods corresponding to a material for forming the alignment film can be used. Examples thereof include a method including: applying the alignment film to a surface of the support; drying the applied alignment film; and exposing the alignment film to laser light to form an alignment pattern.

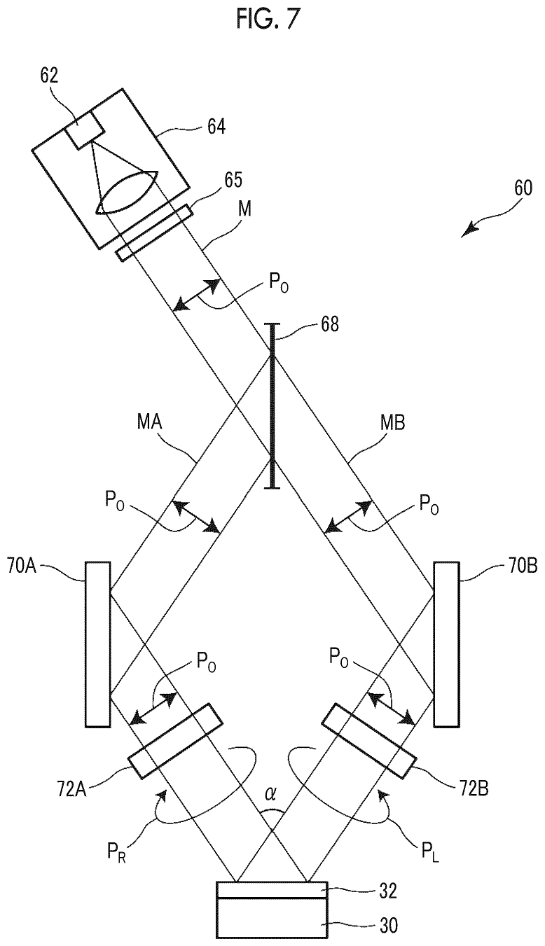

FIG. 7 conceptually shows an example of an exposure device that exposes the alignment film to form an alignment pattern.

An exposure device 60 shown in FIG. 7 includes: a light source 64 including a laser 62; an λ/2 plate 65 that changes a polarization direction of laser light M emitted from the laser 62; a beam splitter 68 that splits the laser light M emitted from the laser 62 into two beams MA and MB; mirrors 70A and 70B that are disposed on optical paths of the split two beams MA and MB; and λ/4 plates 72A and 72B.

The light source 64 emits linearly polarized light P_{O}. The λ/4 plate 72A converts the linearly polarized light P_{O} (beam MA) into right circularly polarized light P_{R}, and the λ/4 plate 72B converts the linearly polarized light P_{O} (beam MB) into left circularly polarized light P_{L}.

The support 30 including the alignment film 32 on which the alignment pattern is not yet formed is disposed at an exposed portion, the two beams MA and MB intersect and interfere with each other on the alignment film 32, and the alignment film 32 is irradiated with and exposed to the interference light.

Due to the interference in this case, the polarization state of light with which the alignment film 32 is irradiated periodically changes according to interference fringes. As a result, an alignment film (hereinafter, also referred to as “patterned alignment film”) having an alignment pattern in which the alignment state changes periodically is obtained.

In the exposure device 60, by changing an intersecting angle α between the two beams MA and MB, the period of the alignment pattern can be adjusted. That is, by adjusting the intersecting angle α in the exposure device 60, in the alignment pattern in which the optical axis 40A derived from the liquid crystal compound 40 continuously rotates in the one in-plane direction, the length of the single period over which the optical axis 40A rotates by 180° in the one direction in which the optical axis 40A rotates can be adjusted.

By forming the optically-anisotropic layer on the alignment film 32 having the alignment pattern in which the alignment state periodically changes, the optically-anisotropic layer having the liquid crystal alignment pattern in which the optical axis 40A derived from the liquid crystal compound 40 continuously rotates in the one direction can be formed.

In addition, by rotating the optical axes of the λ/4 plates 72A and 72B by 90°, respectively, the rotation direction of the optical axis 40A can be reversed.

As described above, the patterned alignment film has an alignment pattern to obtain the liquid crystal alignment pattern in which the liquid crystal compound is aligned such that the orientation of the optical axis of the liquid crystal compound in the optically-anisotropic layer formed on the patterned alignment film changes while continuously rotating in at least one in-plane direction. In a case where an axis along the orientation in which the liquid crystal compound is aligned is an alignment axis, it can be said that the patterned alignment film has an alignment pattern in which the orientation of the alignment axis changes while continuously rotating in at least one in-plane direction. The alignment axis of the patterned alignment film can be detected by measuring absorption anisotropy. For example, in a case where the amount of light transmitted through the patterned alignment film is measured by irradiating the patterned alignment film with linearly polarized light while rotating the patterned alignment film, it is observed that an orientation in which the light amount is the maximum or the minimum gradually changes in the one in-plane direction.

In the present invention, the alignment film is provided as a preferable aspect and is not a configuration requirement.

For example, the following configuration can also be adopted, in which, by forming the alignment pattern on the support using a method of rubbing the support, a method of processing the support with laser light or the like, the optically-anisotropic layer has the liquid crystal alignment pattern in which the orientation of the optical axis 40A derived from the liquid crystal compound 40 changes while continuously rotating in at least one in-plane direction. That is, in the present invention, the support may be made to act as the alignment film.

### (Formation of Optically-Anisotropic Layer)

The optically-anisotropic layer can be formed by immobilizing a liquid crystal phase in a layer shape, the liquid crystal phase being aligned in a liquid crystal alignment pattern in which an orientation of an optical axis derived from the liquid crystal compound changes while continuously rotating in at least one in-plane direction.

The structure in which a liquid crystal phase is immobilized may be a structure in which the alignment of the liquid crystal compound as a liquid crystal phase is immobilized. Typically, the structure in which a liquid crystal phase is immobilized is preferably a structure which is obtained by aligning the polymerizable liquid crystal compound in the liquid crystal alignment pattern, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

The structure in which a liquid crystal phase is immobilized is not particularly limited as long as the optical characteristics of the liquid crystal phase are maintained, and the liquid crystal compound 40 in the optically-anisotropic layer does not necessarily exhibit liquid crystallinity. For example, the molecular weight of the polymerizable liquid crystal compound may be increased by a curing reaction such that the liquid crystallinity thereof is lost.

Examples of a material used for forming the optically-anisotropic layer obtained by immobilizing a liquid crystal phase include a liquid crystal composition including a liquid crystal compound. It is preferable that the liquid crystal compound is a polymerizable liquid crystal compound.

In addition, the liquid crystal composition used for forming the optically-anisotropic layer may further include a surfactant and a polymerization initiator.

### —Polymerizable Liquid Crystal Compound—

The polymerizable liquid crystal compound may be a rod-like liquid crystal compound or a disk-like liquid crystal compound.

Examples of the rod-like polymerizable liquid crystal compound for forming an optically-anisotropic layer include a rod-like nematic liquid crystal compound. As the rod-like nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolan compound, or an alkenylcyclohexylbenzonitrile compound is preferably used. Not only a low-molecular-weight liquid crystal compound but also a polymer liquid crystal compound can be used.

The polymerizable liquid crystal compound can be obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups in the polymerizable liquid crystal compound is preferably 1 to 6 and more preferably 1 to 3.

Examples of the polymerizable liquid crystal compound include compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-328973A. Two or more polymerizable liquid crystal compounds may be used in combination. In a case where two or more polymerizable liquid crystal compounds are used in combination, the alignment temperature can be decreased.

In addition, as a polymerizable liquid crystal compound other than the above-described examples, for example, a cyclic organopolysiloxane compound having a cholesteric phase described in JP1982-165480A (JP-S57-165480A) can be used. Further, as the above-described polymer liquid crystal compound, for example, a polymer in which a liquid crystal mesogenic group is introduced into a main chain, a side chain, or both a main chain and a side chain, a polymer cholesteric liquid crystal in which a cholesteryl group is introduced into a side chain, a liquid crystal polymer described in JP1997-133810A (JP-H9-133810A), and a liquid crystal polymer described in JP1999-293252A (JP-H11-293252A) can be used.

### —Disk-Like Liquid Crystal Compound—

As the disk-like liquid crystal compound, for example, compounds described in JP2007-108732A and JP2010-244038A can be preferably used.

In addition, the addition amount of the polymerizable liquid crystal compound in the liquid crystal composition is preferably 75 to 99.9 mass %, more preferably 80 to 99 mass %, and still more preferably 85 to 90 mass % with respect to the solid content mass (mass excluding a solvent) of the liquid crystal composition.

The kind of the liquid crystal compound is not particularly limited as long as it can be aligned in the liquid crystal alignment pattern in which an orientation of an optical axis derived from the liquid crystal compound changes while continuously rotating in at least one in-plane direction and can satisfy the range of Δn defined by the present invention. However, from the viewpoint of reducing the coloration of high Δn, a tolane type liquid crystal compound and a thiotolane type liquid crystal compound can be suitably used. As the tolane type liquid crystal compound, a compound described in WO2019/182129A is preferable.

In addition, in order to further realize high Δn, a compound represented by Formula (I) below is preferable.

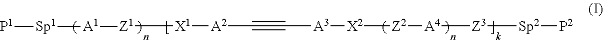

In Formula (I),
P¹ and P² each independently represent a hydrogen atom, —CN, —NCS, or a polymerizable group.
Sp¹ and Sp² each independently represent a single bond or a divalent linking group. Here, Sp¹ and Sp² do not represent a divalent linking group including at least one group selected from the group consisting of an aromatic hydrocarbon ring group, an aromatic heterocyclic group, and an aliphatic hydrocarbon ring group.
Z¹, Z², and Z³ each independently represent a single bond, —O—, —S—, —CHR—, —CHRCHR—, —OCHR—, —CHRO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR═CR—, —CR═N—, —N═CR—, —N═N—, —CR═N—N═CR—, —CF═CF—, or —C≡C—. R represents a hydrogen atom or an alkyl group having 1 to 10 carbon atoms. In a case where a plurality of R's are present, R's may be the same as or different from each other. In a case where a plurality of Z¹'s and a plurality of Z²'s are present, Z¹'s and Z²'s may be the same as or different from each other. In a case where a plurality of Z³'s are present, Z³'s may be the same as or different from each other. Here, Z³ connected to SP² represents a single bond.
X¹ and X² each independently represent a single bond or —S—. In a case where a plurality of X¹'s and a plurality of X²'s are present, X¹'s and X²'s may be the same as or different from each other. Here, among the plurality of X¹'s and the plurality of X²'s, at least one represents —S—.
k represents an integer of 2 to 4.
m and n each independently represent an integer of 0 to 3. In a case where a plurality of m's are present, m's may be the same as or different from each other.

A¹, A², A³, and A⁴ each independently represent a group represented by any one of Formulae (B-1) to (B-7) or a group where two or three groups among the groups represented by Formulae (B-1) to (B-7) are linked. In a case where a plurality of A²'s and a plurality of A³'s are present, A²'s and A³'s may be the same as or different from each other. In a case where a plurality of A¹'s and a plurality of A⁴'s are present, A¹'s and A⁴'s may be the same as or different from each other.

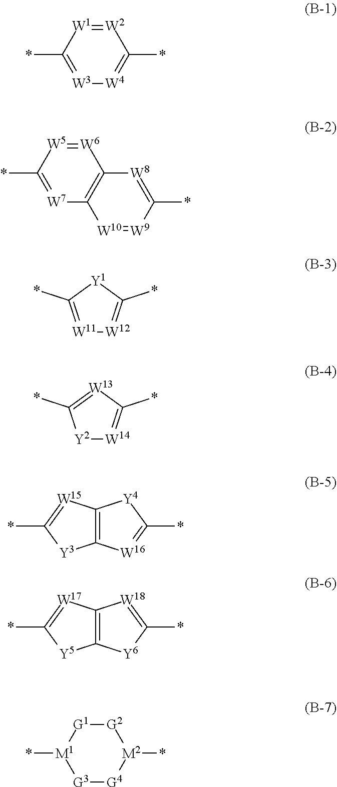

In Formulae (B-1) to (B-7),
W¹ to W¹⁸ each independently represent CR¹ or N, and R¹ represents a hydrogen atom or the following substituent L.
Y¹ to Y⁶ each independently represent NR², O, or S, and R² represents a hydrogen atom or the following substituent L.
G¹ to G⁴ each independently represent CR³R⁴, NR, O, or S, and R³ to R⁵ each independently represent a hydrogen atom or the following substituent L.
M¹ and M² each independently represent CR⁶ or N, and R⁶ represents a hydrogen atom or the following substituent L.
* represents a bonding position.

The substituent L represents an alkyl group having 1 to 10 carbon atoms, an alkoxy group having 1 to 10 carbon atoms, an alkylamino group having 1 to 10 carbon atoms, an alkylthio group having 1 to 10 carbon atoms, an alkanoyl group having 1 to 10 carbon atoms, an alkanoyloxy group having 1 to 10 carbon atoms, an alkanoylamino group having 1 to 10 carbon atoms, an alkanoylthio group having 1 to 10 carbon atoms, an alkyloxycarbonyl group having 2 to 10 carbon atoms, an alkylaminocarbonyl group having 2 to 10 carbon atoms, an alkylthiocarbonyl group having 2 to 10 carbon atoms, a hydroxy group, an amino group, a mercapto group, a carboxy group, a sulfo group, an amido group, a cyano group, a nitro group, a halogen atom, or a polymerizable group. Here, in a case where the group described as the substituent L has —CH₂—, a group in which at least one —CH₂— in the group is substituted with —O—, —CO—, —CH═CH—, or —C≡C— is also included in the substituent L. Here, in a case where the group described as the substituent L has a hydrogen atom, a group in which at least one hydrogen atom in the group is substituted with at least one selected from the group consisting of a fluorine atom and a polymerizable group is also included in the substituent L.

—Surfactant—

The liquid crystal composition used for forming the optically-anisotropic layer may include a surfactant.

It is preferable that the surfactant is a compound that can function as an alignment control agent contributing to the stable or rapid alignment of the liquid crystal compound. Examples of the surfactant include a silicone-based surfactant and a fluorine-based surfactant. Among these, a fluorine-based surfactant is preferable.

Specific examples of the surfactant include compounds described in paragraphs “0082” to “0090” of JP2014-119605A, compounds described in paragraphs “0031” to “0034” of JP2012-203237A, exemplary compounds described in paragraphs “0092” and “0093” of JP2005-99248A, exemplary compounds described in paragraphs “0076” to “0078” and paragraphs “0082” to “0085” of JP2002-129162A, and fluorine (meth)acrylate polymers described in paragraphs “0018” to “0043” of JP2007-272185A.

The surfactants may be used alone or in combination of two or more kinds.

As the fluorine-based surfactant, a compound described in paragraphs “0082” to “0090” of JP2014-119605A is preferable.

The addition amount of the surfactant in the liquid crystal composition is preferably 0.01 to 10 mass %, more preferably 0.01 to 5 mass %, and still more preferably 0.02 to 1 mass % with respect to the total mass of the liquid crystal compound.

### —Polymerization Initiator—

In a case where the liquid crystal composition includes a polymerizable compound, it is preferable that the liquid crystal composition includes a polymerization initiator. In an aspect where a polymerization reaction progresses with ultraviolet irradiation, it is preferable that the polymerization initiator to be used is a photopolymerization initiator which initiates a polymerization reaction with ultraviolet irradiation.

Examples of the photopolymerization initiator include an α-carbonyl compound (described in U.S. Pat. Nos. 2,367,661A and 2,367,670A), an acyloin ether (described in U.S. Pat. No. 2,448,828A), an α-hydrocarbon-substituted aromatic acyloin compound (described in U.S. Pat. No. 2,722,512A), a polynuclear quinone compound (described in U.S. Pat. Nos. 3,046,127A and 2,951,758A), a combination of a triarylimidazole dimer and p-aminophenyl ketone (described in U.S. Pat. No. 3,549,367A), an acridine compound and a phenazine compound (described in JP1985-105667A (JP-S60-105667A) and U.S. Pat. No. 4,239,850A), and an oxadiazole compound (described in U.S. Pat. No. 4,212,970A).

The content of the photopolymerization initiator in the liquid crystal composition is preferably 0.1 to 20 mass % and more preferably 0.5 to 12 mass % with respect to the content of the liquid crystal compound.

### —Crosslinking Agent—

In order to improve the film hardness after curing and to improve durability, the liquid crystal composition may optionally include a crosslinking agent. As the crosslinking agent, a curing agent which can perform curing with ultraviolet light, heat, moisture, or the like can be suitably used.

The crosslinking agent is not particularly limited and can be appropriately selected depending on the purpose. Examples of the crosslinking agent include: a polyfunctional acrylate compound such as trimethylol propane tri(meth)acrylate or pentaerythritol tri(meth)acrylate; an epoxy compound such as glycidyl (meth)acrylate or ethylene glycol diglycidyl ether; an aziridine compound such as 2,2-bis hydroxymethyl butanol-tris[3-(1-aziridinyl)propionate] or 4,4-bis(ethyleneiminocarbonylamino)diphenylmethane; an isocyanate compound such as hexamethylene diisocyanate or a biuret type isocyanate; a polyoxazoline compound having an oxazoline group at a side chain thereof, and an alkoxysilane compound such as vinyl trimethoxysilane or N-(2-aminoethyl)-3-aminopropyltrimethoxysilane. In addition, depending on the reactivity of the crosslinking agent, a well-known catalyst can be used, and not only film hardness and durability but also productivity can be improved. The crosslinking agents may be used alone or in combination of two or more kinds.

The content of the crosslinking agent is preferably 3% to 20 mass % and more preferably 5% to 15 mass % with respect to the solid content mass of the liquid crystal composition. In a case where the content of the crosslinking agent is in the above-described range, an effect of improving a crosslinking density can be easily obtained, and the stability of a liquid crystal phase is further improved.

### —Other Additives—

Optionally, a polymerization inhibitor, an antioxidant, an ultraviolet absorber, a light stabilizer, a coloring material, metal oxide fine particles, or the like can be added to the liquid crystal composition in a range where optical performance and the like do not deteriorate.

It is preferable that the liquid crystal composition is used as a liquid during the formation of the optically-anisotropic layer (during the application to the alignment film).

The liquid crystal composition may include a solvent. The solvent is not particularly limited and can be appropriately selected depending on the purpose. An organic solvent is preferable.

The organic solvent is not particularly limited and can be appropriately selected depending on the purpose. Examples of the organic solvent include a ketone, an alkyl halide, an amide, a sulfoxide, a heterocyclic compound, a hydrocarbon, an ester, and an ether. The organic solvents may be used alone or in combination of two or more kinds. Among these, a ketone is preferable in consideration of an environmental burden.

In a case where the optically-anisotropic layer is formed, it is preferable that the optically-anisotropic layer is formed by applying the liquid crystal composition to a surface where the optically-anisotropic layer is to be formed, aligning the liquid crystal compound to a state the liquid crystal phase aligned in the predetermined liquid crystal alignment pattern, and curing the liquid crystal compound.

That is, in a case where the optically-anisotropic layer is formed on the alignment film, it is preferable that the optically-anisotropic layer obtained by immobilizing a liquid crystal phase is formed by applying the liquid crystal composition to the alignment film, aligning the liquid crystal compound in the predetermined liquid crystal alignment pattern, and curing the liquid crystal compound.

For the application of the liquid crystal composition, a printing method such as ink jet or scroll printing or a well-known method such as spin coating, bar coating, or spray coating capable of uniformly applying liquid to a sheet-shaped material can be used.

The applied liquid crystal composition is optionally dried and/or heated and then is cured to form the optically-anisotropic layer. In the drying and/or heating step, the liquid crystal compound in the liquid crystal composition only has to be aligned in the predetermined liquid crystal alignment pattern. In the case of heating, the heating temperature is preferably 200° C. or lower and more preferably 130° C. or lower.

The aligned liquid crystal compound is optionally further polymerized. Regarding the polymerization, thermal polymerization or photopolymerization using light irradiation may be performed, and photopolymerization is preferable. Regarding the light irradiation, ultraviolet light is preferably used. The irradiation energy is preferably 20 mJ/cm² to 50 J/cm² and more preferably 50 to 1500 mJ/cm². In order to promote a photopolymerization reaction, light irradiation may be performed under heating conditions or in a nitrogen atmosphere. The wavelength of irradiated ultraviolet light is preferably 250 to 430 nm.

The optically-anisotropic layer may be formed with a desired thickness by multiple application where the operations including the application to the polymerization are repeated.

The optically-anisotropic layers may be laminated in a state where they are laminated on the support and the alignment film. Alternatively, the optically-anisotropic layers may be laminated, for example, in a state where only the alignment film and the optically-anisotropic layers are laminated after peeling off the support. Alternatively, the optically-anisotropic layers may be laminated, for example, in a state where only the optically-anisotropic layers are laminated after peeling off the support and the alignment film.

Here, the first optically-anisotropic layer and the second and third optically-anisotropic layers having different birefringences Δn may be formed using different liquid crystal compounds. That is, the first optically-anisotropic layer may be formed of a liquid crystal composition including a liquid crystal compound having a high birefringence Δn, and the second and third optically-anisotropic layers may be formed of a liquid crystal composition including a liquid crystal compound having a low birefringence Δn. Alternatively, a Δn distribution can be formed in the thickness direction to form the first to third optically-anisotropic layers by a temperature gradient using a liquid crystal material where Δn can be controlled depending on temperatures. In this case, a liquid crystal compound described in JP2009-175208A can be preferably used.

In addition, for example, in a configuration including three optically-anisotropic layers as in the optical element according to the embodiment of the present invention, first, the third optically-anisotropic layer may be formed on the alignment film, the first optically-anisotropic layer may be formed directly on the third optically-anisotropic layer, and the second optically-anisotropic layer may be formed directly on the first optically-anisotropic layer. In this case, the first optically-anisotropic layer is aligned in the same liquid crystal alignment pattern as the third optically-anisotropic layer, and the second optically-anisotropic layer is aligned in the same liquid crystal alignment pattern as the first optically-anisotropic layer.

Here, in the optically-anisotropic layer shown in FIG. 3, the optical axes of the liquid crystal compounds arranged in the thickness direction are aligned in the same direction. However, the present invention is not limited to this configuration. The optically-anisotropic layer may have a region where the optical axis of the liquid crystal compound is twisted along the thickness direction in a plane. In this case, in the region including the twisted structure in the thickness direction, a twisted angle in the thickness direction is 10° to 360°.

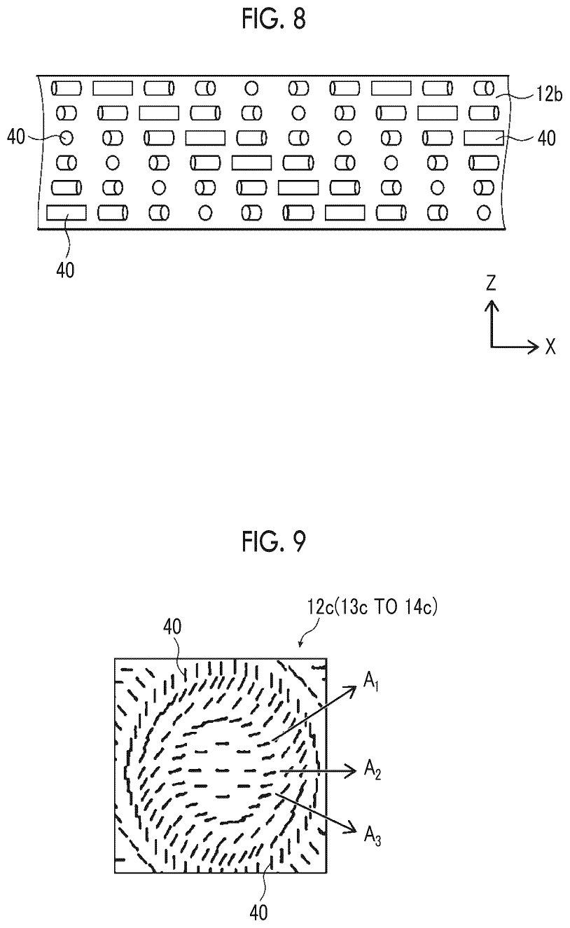

FIG. 8 is a diagram conceptually showing another example of the first optically-anisotropic layer in the optical element according to the embodiment of the present invention.

A first optically-anisotropic layer 12b shown in FIG. 8 has the same configuration as the optically-anisotropic layer shown in FIGS. 3 and 4, except that the liquid crystal compound is twisted and aligned in the thickness direction. That is, in a case where the first optically-anisotropic layer 12b shown in FIG. 8 is seen from the thickness direction, as in the example shown in FIG. 4, the first optically-anisotropic layer 12b has a liquid crystal alignment pattern in which the orientation of the optical axis 40A changes while continuously rotating along the arrangement axis D in a plane.

The first optically-anisotropic layer 12b shown in FIG. 8 has a twisted structure in which the liquid crystal compound 40 is turned and laminated in the thickness direction, and a total rotation angle between the liquid crystal compound 40 present on one main surface side of the first optically-anisotropic layer 12b and the liquid crystal compound 40 present on another main surface side of the first optically-anisotropic layer 12b is 360° or less.

This way, in a case where the optically-anisotropic layer has the liquid crystal alignment pattern where the orientation of the optical axis 40A changes while continuously rotating along the arrangement axis D in a plane and has the structure where the liquid crystal compound 40 is twisted in the thickness direction, in a cross section parallel to the arrangement axis D, a line segment that connect the liquid crystal compounds 40 directed in the same direction in the thickness direction is tilted with respect to the main surface of the optically-anisotropic layer. In an image obtained by observing a cross-section of the optically-anisotropic layer taken in the thickness direction along the arrangement axis D with a scanning electron microscope (SEM), a stripe pattern of bright portions and dark portions to be observed is tilted with respect to the main surface. As a result, the diffraction efficiency of the optical element can be further improved.

This way, in order for the optically-anisotropic layer to have the configuration where the liquid crystal compound is twisted and aligned in the thickness direction, the liquid crystal composition for forming the optically-anisotropic layer may contain a chiral agent.

### —Chiral Agent (Optically Active Compound)—

The chiral agent has a function of causing a helical structure of a liquid crystal phase to be formed. The chiral agent may be selected depending on the purposes because a helical twisted direction and a helical twisting power (HTP) to be induced vary depending on compounds.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

In a case where the chiral agent includes a photoisomerization group, a desired twisted alignment corresponding to a luminescence wavelength can be formed by irradiation of an actinic ray or the like through a photomask after coating and alignment, which is preferable. As the photoisomerization group, an isomerization portion of a photochromic compound, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01 to 200 mol % and more preferably 1 to 30 mol % with respect to the content molar amount of the liquid crystal compound.

In the above description, the configuration where the first optically-anisotropic layer includes the twisted structure in the thickness direction is adopted. However, a configuration in which the second optically-anisotropic layer and/or the third optically-anisotropic layer includes the twisted structure in the thickness direction may be adopted, and a configuration in which the optically-anisotropic layers include the twisted structure in the thickness direction may be adopted. As described above, the first optically-anisotropic layer contributes to diffraction of light. Therefore, with the configuration in which the first optically-anisotropic layer includes the twisted structure in the thickness direction, the diffraction efficiency can be further improved.

In addition, the first optically-anisotropic layer may be configured to include regions where twisted states (twisted angles and twisted directions) are different in the thickness direction. In this configuration, in a cross sectional image obtained by observing a cross section of the optically-anisotropic layer taken in the thickness direction along the one direction in which the orientation of the optical axis of the liquid crystal compound changes while continuously rotating with a scanning electron microscope, a bright portion and a dark portion extending from one main surface to another main surface are observed, and the dark portion has one or two or more inflection points of angle.

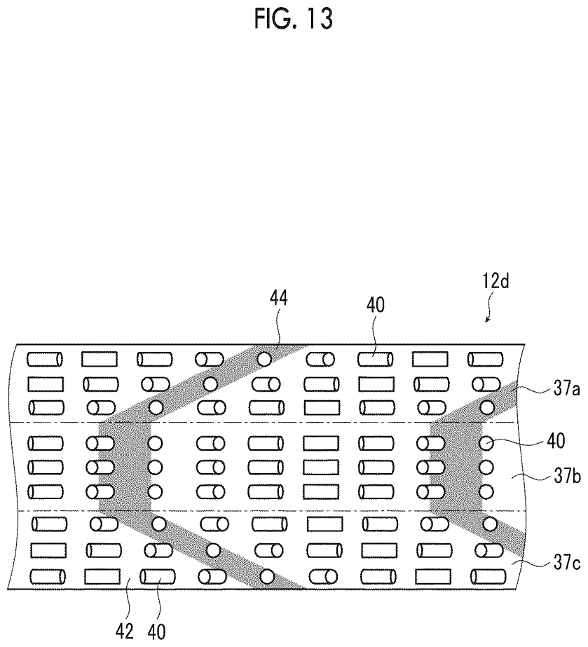

FIG. 13 shows an example of the optically-anisotropic layer. In FIG. 13, bright portions 42 and dark portions 44 are shown to overlap a cross section of an optically-anisotropic layer 12d. In the following description, the image obtained by observing the cross section taken in the thickness direction along the one direction in which the optical axis rotates with an SEM will also be simply referred to as “cross-sectional SEM image”.

In the cross-sectional SEM image of the optically-anisotropic layer 12d shown in FIG. 13, the dark portion 44 has two inflection points where the angle changes. That is, the optically-anisotropic layer 12d can also include three regions including a region 37a, a region 37b, and a region 37c corresponding to the inflection points of the dark portion 44 in the thickness direction.

The optically-anisotropic layer 12d also has, at any position in the thickness direction, the liquid crystal alignment pattern where the optical axis derived from the liquid crystal compound 40 rotates clockwise to the left direction in the drawing in the in-plane direction. In addition, the single period of the liquid crystal alignment pattern is fixed in the thickness direction.

In addition, as shown in FIG. 13, in the lower region 37c in the thickness direction, the liquid crystal compound 40 is twisted and aligned to be helically twisted clockwise (to the right) from the upper side to the lower side in the drawing in the thickness direction.

In the middle region 37b in the thickness direction, the liquid crystal compound 40 is not twisted in the thickness direction, and the optical axes of the liquid crystal compounds 40 laminated in the thickness direction face the same direction. That is, the optical axes of the liquid crystal compounds 40 present at the same position in the in-plane direction face the same direction.

In the upper region 37a in the thickness direction, the liquid crystal compound 40 is twisted and aligned to be helically twisted counterclockwise (to the left) from the upper side to the lower side in the drawing in the thickness direction.

That is, in the region 37a, the region 37b, and the region 37c of the optically-anisotropic layer 12d shown in FIG. 13, the twisted states of the liquid crystal compounds 40 in the thickness direction are different from each other.

In the optically-anisotropic layer having the liquid crystal alignment pattern in which the optical axis derived from the liquid crystal compound continuously rotates in the one direction, the bright portions and the dark portions in the cross-sectional SEM image of the optically-anisotropic layer are observed to connect the liquid crystal compounds facing the same orientation.

For example, in FIG. 13, the dark portions 44 are observed to connect the liquid crystal compounds 40 of which the optical axes face a direction orthogonal to the paper plane.

In the lowermost region 37c in the thickness direction, the dark portion 44 is tilted to the upper left side in the drawing. In the middle region 37b, the dark portion 44 extends in the thickness direction. In the uppermost region 37a, the dark portion 44 is tilted to the upper right side in the drawing.

That is, the optically-anisotropic layer 12d shown in FIG. 13 has two inflection points of angle where the angle of the dark portion 44 changes. In addition, in the uppermost region 37a, the dark portion 44 is tilted to the upper right side. In the lowermost region 37b, the dark portion 44 is tilted to the upper left side. That is, in the region 37a and the region 37c, the tilt directions of the dark portions 44 are different from each other.

Further, the optically-anisotropic layer 12d shown in FIG. 13 has one inflection point where the dark portion 44 is folded in a direction opposite to the tilt direction.

Specifically, regarding the dark portion 44 of the optically-anisotropic layer 12d, the tilt direction in the region 37a and the tilt direction in the region 37b are opposite to each other. Therefore, at the inflection point positioned at the interface between the region 37a and the region 37b, the tilt direction is folded in the opposite direction. That is, the optically-anisotropic layer 12d has one inflection point where the tilt direction is folded in the opposite direction.

In addition, in the region 37a and the region 37c of the optically-anisotropic layer 12d, for example, the thicknesses are the same, and the twisted states of the liquid crystal compounds 40 in the thickness direction are different from each other. Therefore, as shown in FIG. 13, the bright portions 42 and the dark portions 44 in the cross-sectional SEM image are formed in a substantially C-shape.

Accordingly, in the optically-anisotropic layer 12d, the shape of the dark portion 44 is symmetrical with respect to the center line in the thickness direction.

In addition, in the optical element according to the embodiment of the present invention, the optically-anisotropic layer 12d, that is, the cross-sectional SEM image has the bright portions 42 and the dark portions 44 extending from one surface to another surface, each of the dark portions 44 has one or two or more inflection points of angle. As a result, the wavelength dependence of the diffraction efficiency can be reduced, and light can be diffracted with the same diffraction efficiency irrespective of wavelengths.

In the example shown in FIG. 13, the dark portion 44 is configured to have two inflection points of angle. However, the present invention is not limited to this configuration, and the dark portion 44 may have one inflection point of angle or may have three or more inflection points of angle. For example, in the configuration where the dark portion 44 of the optically-anisotropic layer has one inflection point of angle, for example, the optically-anisotropic layer may consist of the region 37a and the region 37c shown in FIG. 13, may consist of the region 37a and the region 37b, or may consist of the region 37b and the region 37c. Alternatively, in the configuration where the dark portion 44 of the optically-anisotropic layer has three inflection points of angle, the region 37a and the region 37c shown in FIG. 13 may be alternately provided two by two.

In addition, in the liquid crystal alignment pattern of the optically-anisotropic layer shown in FIG. 4, the arrangement axis D is present in the one in-plane direction, and the optical axis 40A of the liquid crystal compound 40 continuously rotates in the one direction along the arrangement axis D direction.

However, the present invention is not limited thereto, and various configurations can be used as long as the optical axis 40A of the liquid crystal compound 40 in the optically-anisotropic layer continuously rotates in the one direction.

For example, as conceptually shown in a plan view of FIG. 9, a first optically-anisotropic layer 12c, a second optically-anisotropic layer 13c, and a third optically-anisotropic layer 14c (hereinafter, collectively referred to as the optically-anisotropic layer 12c) may be configured to include the liquid crystal alignment pattern in a radial shape. In the optically-anisotropic layer 12c shown in FIG. 9, the orientation of the optical axis of the liquid crystal compound 40 changes while continuously rotating in a plurality of directions from the center toward the outer side of the optically-anisotropic layer 12c, for example, a direction indicated by an arrow A₁, a direction indicated by an arrow A₂, a direction indicated by an arrow A₃, or . . . . That is, the arrows A₁, A₂, and A₃ are arrangement axes.

In addition, as shown in FIG. 9, the optical axis of the liquid crystal compound 40 changes while rotating in the same direction from the center toward the outer side of the optically-anisotropic layer 12c. In the aspect shown in FIG. 9, the counterclockwise alignment is shown. The rotation directions in which the optical axes rotate and change along the respective arrows A₁, A₂, and A₃ in FIG. 9 are counterclockwise from the center toward the outer side.

In the radial liquid crystal alignment pattern, a line that connects liquid crystal compounds of which optical axes face the same direction has a circular shape, and a circular line segment is a concentric circular pattern.

In the optically-anisotropic layer 12c having the radial liquid crystal alignment pattern, in a case where incident light is diffracted along each of the arrangement axes (for example, A₁ to A₃) such that an azimuth direction faces the center side, transmitted light can be collected. Alternatively, in a case where incident light is diffracted along each of the arrangement axes (for example, A₁ to A₃) such that an azimuth direction faces the outer side, transmitted light can be diffused. Whether or not transmitted light is diffracted toward the center side or toward the outer side depends on the polarization state of the incident light and the rotation direction of the optical axis in the liquid crystal alignment pattern.

This way, in the present invention, by setting the liquid crystal alignment pattern of the optically-anisotropic layer to the radial pattern, a lens that collects or diffuses light can be obtained.

In a case where the optical element is used as the lens, it is preferable that the diffraction angle gradually increases from the center toward the outer side of the optical element. As a result, the optical element can collect or diffuse light more suitably.

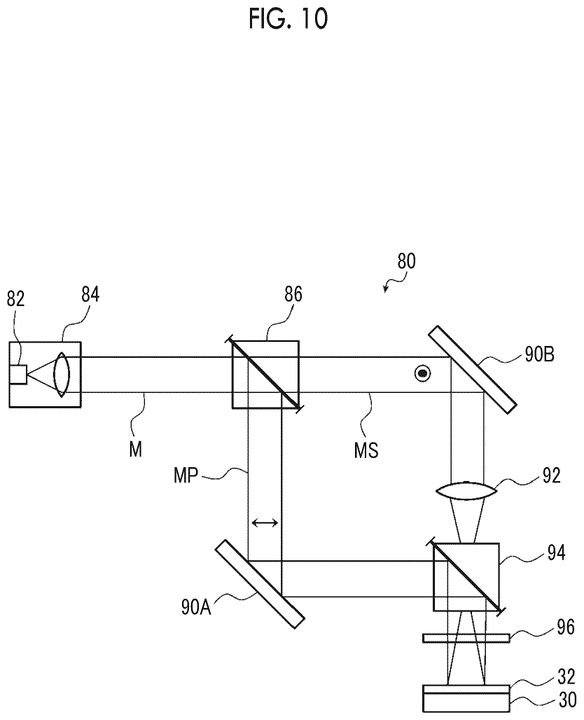

In addition, FIG. 10 shows an example of an exposure device that forms the radial liquid crystal alignment pattern shown in FIG. 9.

An exposure device 80 shown in FIG. 10 includes: a light source 84 that includes a laser 82; a polarization beam splitter 86 that splits the laser light M emitted from the laser 82 into S polarized light MS and P polarized light MP; a mirror 90A that is disposed on an optical path of the P polarized light MP; a mirror 90B that is disposed on an optical path of the S polarized light MS; a lens 92 that is disposed on the optical path of the S polarized light MS; a polarization beam splitter 94; and a λ/4 plate 96.

The P polarized light MP that is split by the polarization beam splitter 86 is reflected from the mirror 90A to be incident into the polarization beam splitter 94. On the other hand, the S polarized light MS that is split by the polarization beam splitter 86 is reflected from the mirror 90B and is collected by the lens 92 to be incident into the polarization beam splitter 94.

The P polarized light MP and the S polarized light MS are combined by the polarization beam splitter 94, are converted into right circularly polarized light and left circularly polarized light by the λ/4 plate 96 depending on the polarization direction, and are incident into the alignment film 32 on the support 30.

Here, due to interference between the right circularly polarized light and the left circularly polarized light, the polarization state of light with which the alignment film 32 is irradiated periodically changes according to interference fringes. The intersecting angle between the right circularly polarized light and the left circularly polarized light changes from the inner side to the outer side of the concentric circle. Therefore, an exposure pattern in which the period changes from the inner side to the outer side can be obtained. As a result, in the alignment film 32, the radial alignment pattern in which the alignment state periodically changes can be obtained.

In the exposure device 80, the length Λ of the single period in the liquid crystal alignment pattern in which the optical axis of the liquid crystal compound 40 continuously rotates by 180° can be controlled by changing the refractive power of the lens 92 (the F number of the lens 92), the focal length of the lens 92, the distance between the lens 92 and the alignment film 32, and the like.

In addition, by adjusting the refractive power of the lens 92 (the F number of the lens 92), the length Λ of the single period in the liquid crystal alignment pattern in the one direction in which the optical axis continuously rotates can be changed. Specifically, In addition, the length Λ of the single period in the liquid crystal alignment pattern in the one direction in which the optical axis continuously rotates can be changed depending on a light spread angle at which light is spread by the lens 92 due to interference with parallel light. More specifically, in a case where the refractive power of the lens 92 is weak, light is approximated to parallel light. Therefore, the length Λ of the single period in the liquid crystal alignment pattern gradually decreases from the inner side toward the outer side, and the F number increases. Conversely, in a case where the refractive power of the lens 92 becomes stronger, the length Λ of the single period in the liquid crystal alignment pattern rapidly decreases from the inner side toward the outer side, and the F number decreases.

### [Image Display Apparatus]

An image display apparatus according to the embodiment of the present invention is an image display apparatus including the above-described optical element.

Specific examples of the image display apparatus include a head mounted display such as Augmented Reality (AR) glasses or Virtual Reality (VR), a liquid crystal display device, and a projector.

For example, in a case where the image display apparatus is AR glasses, the AR glasses may have the same configuration as well-known AR glasses except that they include a light guide element including the above-described optical element. For example, the AR glasses may include a display element that projects a video, a projection lens, a λ/4 plate, and a linearly polarizing plate.

Examples of the display element include a liquid crystal display (LCOS including Liquid Crystal On Silicon), an organic electroluminescent display, and a scanning type display employing a digital light processing (DLP) or Micro Electro Mechanical Systems (MEMS) mirror.

The display element may display a monochrome image, a two-color image, or a color image.

The projection lens may be a well-known projection lens (condenser lens) used for AR glasses or the like.

In addition, in a case where the display element emits an image of unpolarized light, it is preferable that the image display apparatus further includes a circularly polarizing plate consisting of a linearly polarizing plate and a λ/4 plate. In addition, in a case where the display element emits an image of linearly polarized light, it is preferable that the image display apparatus includes, for example, a λ/4 plate.

The light to be emitted from the display may be, for example, another polarized light such as linearly polarized light.

### EXAMPLES

Hereinafter, the characteristics of the present invention will be described in detail using Examples and Comparative Examples. Materials, used amounts, ratios, treatment details, treatment procedures, and the like shown in the following Examples can be appropriately changed within a range not departing from the scope of the present invention. Accordingly, the scope of the present invention is not limited to the following specific examples.

### Example 1

### (Formation of Alignment Film)

The following coating liquid for forming an alignment film was continuously applied to a glass substrate having a thickness of 1.1 mm formed using a #2 wire bar. The support on which the coating film of the coating liquid for forming an alignment film was formed was dried using a hot plate at 60° C. for 60 seconds. As a result, an alignment film was formed.

Coating Liquid For Forming Alignment Film

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

### Material A for Photo-Alignment

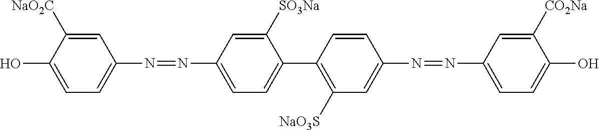

### (Exposure of Alignment Film)

The alignment film was exposed using the exposure device shown in FIG. 7 to form an alignment film P-1 having an alignment pattern.

In the exposure device, a laser that emits laser light having a wavelength (355 nm) was used as the laser. The exposure amount of the interference light was 100 mJ/cm².

### (Formation of Second Optically-Anisotropic Layer)

As the liquid crystal composition forming the second optically-anisotropic layer, the following composition A-1 was prepared.

Composition A-1

| | | |
|---|---|---|
| Liquid crystal compound L-1 | 100.00 | parts by mass |
| Chiral agent A having the following structure | 0.11 | parts by mass |
| Polymerization initiator (IRGACURE | 3.00 | parts by mass |
| (registered trade name) 907, | | |
| manufactured by BASF SE) | | |
| Photosensitizer (KAYACURE DETX-S, | 1.00 | part by mass |
| manufactured by Nippon Kayaku Co., Ltd.) | | |
| Leveling agent T-1 | 0.08 | parts by mass |
| Methyl ethyl ketone | 936.00 | parts by mass |

### Liquid Crystal Compound L-1

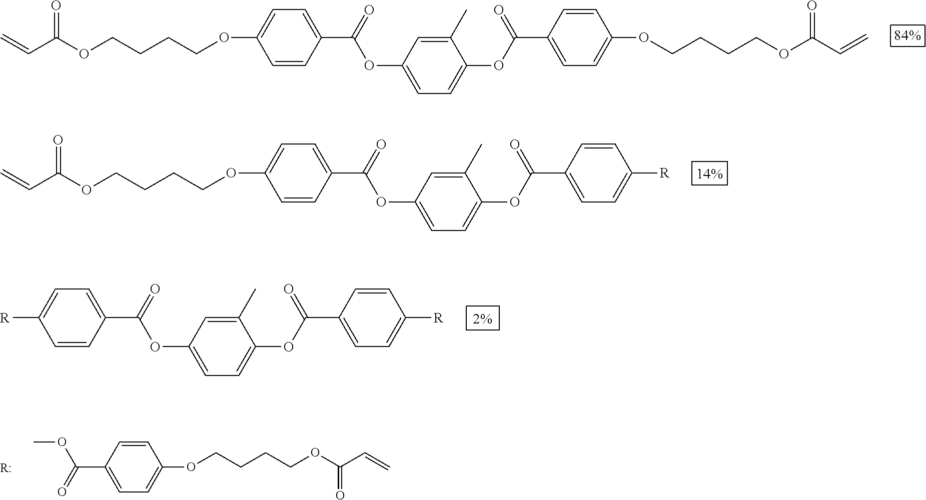

### Chiral Agent A

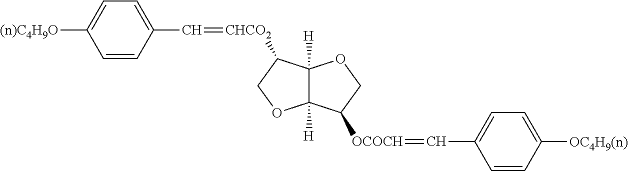

### Leveling Agent T-1

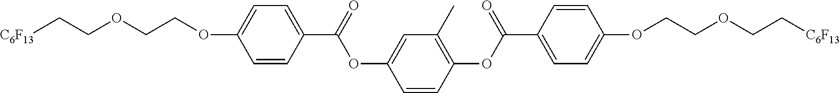

Regarding the second optically-anisotropic layer, the following composition A-1 was applied to the alignment film P-1 to form a coating film, the coating film was heated using a hot plate at 70° C., the coating film was cooled to 25° C., and the coating film was irradiated with ultraviolet light having a wavelength of 365 nm at an irradiation dose of 100 mJ/cm² using a high-pressure mercury lamp in a nitrogen atmosphere. As a result, the alignment of the liquid crystal compound was immobilized. The film thickness of the liquid crystal layer was 0.05 μm.

### (Formation of First Optically-Anisotropic Layer)

As the first optically-anisotropic layer, three layers including first-X, first-Y, and first-Z layers having different twisted angles were dividedly manufactured.

As liquid crystal compositions for forming the first-X, first-Y, and first-Z optically-anisotropic layers, the following compositions B-1, B-2, and B-3 were prepared, respectively.

Composition B-1

| | | |
|---|---|---|
| Liquid crystal compound L-2 | 100.00 | parts by mass |
| Chiral agent C-3 | 0.23 | parts by mass |
| Chiral agent C-4 | 0.82 | parts by mass |
| Polymerization initiator | 1.00 | part by mass |
| (IRGACURE OXE01, | | |
| manufactured by BASF SE) | | |
| Leveling agent T-1 | 0.08 | parts by mass |
| Methyl ethyl ketone | 1050.00 | parts by mass |

### Liquid Crystal Compound L-2

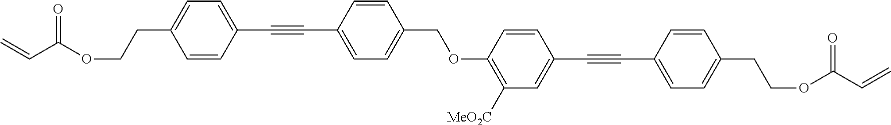 [SMILES: C=CC(=O)OCCc1ccc(C#Cc2ccc(COc3ccc(C#Cc4ccc(CCOC(=O)C=C)cc4)cc3C(=O)OC)cc2)cc1]

### Chiral Agent C-3

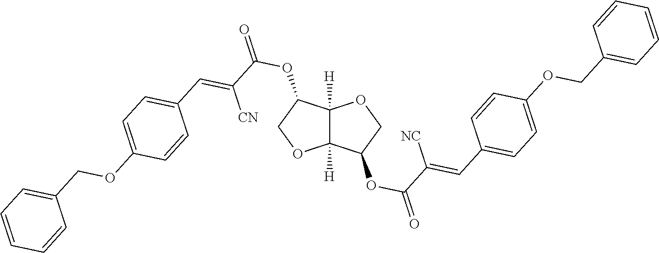 [SMILES: N#C/C(=C\c1ccc(OCc2ccccc2)cc1)C(=O)O[C@H]1CO[C@H]2[C@@H]1OC[C@H]2OC(=O)/C(C#N)=C/c1ccc(OCc2ccccc2)cc1]

### Chiral Agent C-4

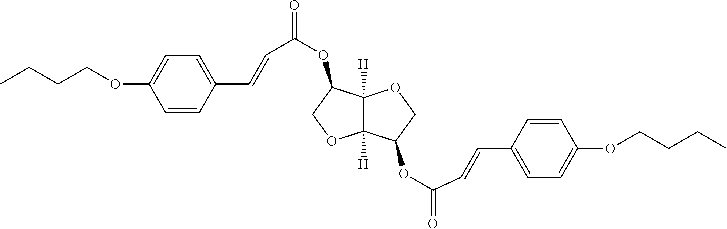 [SMILES: CCCCOc1ccc(/C=C/C(=O)O[C@@H]2CO[C@H]3[C@@H]2OC[C@H]3OC(=O)/C=C/c2ccc(OCCCC)cc2)cc1]

Composition B-2

| | | |
|---|---|---|
| Liquid crystal compound L-2 | 100.00 | parts by mass |
| Chiral agent C-3 | 0.54 | parts by mass |
| Chiral agent C-4 | 0.62 | parts by mass |
| Polymerization initiator | 1.00 | part by mass |
| (IRGACURE OXE01, | | |
| manufactured by BASF SE) | | |
| Leveling agent T-1 | 0.08 | parts by mass |
| Methyl ethyl ketone | 1050.00 | parts by mass |

Composition B-3

| | | |
|---|---|---|
| Liquid crystal | 100.00 | parts by mass |
| compound L-2 | | |
| Chiral agent C-3 | 0.48 | parts by mass |
| Polymerization initiator | 1.00 | part by mass |
| (IRGACURE OXE01, | | |
| manufactured by BASF SE) | | |
| Leveling agent T-1 | 0.08 | parts by mass |
| Methyl ethyl ketone | 1050.00 | parts by mass |

The first region (first-X optically-anisotropic layer) was formed by applying multiple layers of the composition B-1 to the second optically-anisotropic layer. The application of the multiple layers refers to repetition of the following processes including: preparing a first liquid crystal immobilized layer by applying the first layer-forming composition B-1 to the formation surface, heating the composition B-1, cooling the composition B-1, and irradiating the composition B-1 with ultraviolet light for curing; and preparing a second or subsequent liquid crystal immobilized layer by applying the second or subsequent layer-forming composition B-1 to the formed liquid crystal immobilized layer, heating the composition B-1, cooling the composition B-1, and irradiating the composition B-1 with ultraviolet light for curing as described above. Even in a case where the liquid crystal layer was formed by the application of the multiple layers such that the total thickness of the optically-anisotropic layer was large, the alignment direction of the alignment film was reflected from a lower surface of the optically-anisotropic layer to an upper surface thereof.

First, the composition B-1 was applied to the second optically-anisotropic layer, and the coating film was heated to 80° C. on a hot plate. Next, the coating film was irradiated with ultraviolet light having a wavelength of 365 nm using a LED-UV exposure device. Next, the coating film heated on a hot plate at 80° C. was irradiated with ultraviolet light having a wavelength of 365 nm at an irradiation dose of 300 mJ/cm² using a high pressure mercury lamp in a nitrogen atmosphere. As a result, the alignment of the liquid crystal compound was immobilized, and the first liquid crystal immobilized layer of the first-X optically-anisotropic layer was formed.

Regarding the second or subsequent liquid crystal layer, the composition was applied to the liquid crystal immobilized layer, and then a liquid crystal immobilized layer was manufactured under the same conditions as described above. This way, by repeating the application multiple times until the total thickness reached a desired film thickness, the first region of the first optically-anisotropic layer (first-X optically-anisotropic layer) was formed.

In the first region (the first-X optically-anisotropic layer), it was verified with a polarization microscope that Δn₅₅₀×thickness (Re(550)) of the liquid crystal was finally 160 nm and the optically-anisotropic layer was in a periodic alignment state where the single period over which the optical axis of the liquid crystal compound rotated by 180° was 1.8 μm. In addition, the twisted angle of the first-X optically-anisotropic layer in the thickness direction was left-twisted and 80° (−80°).

Next, the first-Y optically-anisotropic layer was formed by applying multiple layers of the composition B-2 to the first-X optically-anisotropic layer.

The composition B-2 was applied to the first-X optically-anisotropic layer, and the first liquid crystal immobilized layer of the first-Y optically-anisotropic layer was formed in the same manufacturing procedure as that of the first-X optically-anisotropic layer, except that the irradiation dose of ultraviolet light with which the coating film was irradiated was changed such that the total thickness was a desired film thickness.

Regarding the second or subsequent liquid crystal layer, the composition was applied to the liquid crystal immobilized layer, and then a liquid crystal immobilized layer was manufactured under the same conditions as described above. This way, by repeating the application multiple times until the total thickness reached a desired thickness, the first-Y optically-anisotropic layer was formed.

In the first-Y optically-anisotropic layer, it was verified with a polarization microscope that Δn₅₅₀×thickness (Re(550)) of the liquid crystal was finally 342 nm and the optically-anisotropic layer was in a periodic alignment state where the single period over which the optical axis of the liquid crystal compound rotated by 180° was 1.8 μm. In addition, the twisted angle of the first-Y optically-anisotropic layer in the thickness direction was right-twisted and 4° (+4°).

Next, the first-Z optically-anisotropic layer was formed by applying multiple layers of the composition B-3 to the first-Y optically-anisotropic layer.

The composition B-3 was applied to the first-Y optically-anisotropic layer, and the first liquid crystal immobilized layer of the first-Z optically-anisotropic layer was formed in the same manufacturing procedure as that of the first-X optically-anisotropic layer, except that the irradiation dose of ultraviolet light with which the coating film was irradiated was changed such that the total thickness was a desired film thickness.

Regarding the second or subsequent liquid crystal layer, the composition was applied to the liquid crystal immobilized layer, and then a liquid crystal immobilized layer was manufactured under the same conditions as described above. This way, by repeating the application multiple times until the total thickness reached a desired thickness, the first-Z optically-anisotropic layer was formed.

In the first-Z region, it was verified with a polarization microscope that Δn₅₅₀×thickness (Re(550)) of the liquid crystal was finally 160 nm and the optically-anisotropic layer was in a periodic alignment state where the single period over which the optical axis of the liquid crystal compound rotated by 180° was 1.8 μm. In addition, the twisted angle of the optically-anisotropic layer in the thickness direction was right-twisted and 80° (+80°).

The first-Z optically-anisotropic layer was formed as described above, and the first optically-anisotropic layer including three regions having different twisted angles in the thickness direction was formed.

### (Formation of Third Optically-Anisotropic Layer)

The following composition C-1 was prepared as a liquid crystal composition for forming the third optically-anisotropic layer.

Composition C-1

| | | |
|---|---|---|
| Liquid crystal compound L-3 | 100.00 | parts by mass |
| Chiral agent A having the | 0.11 | parts by mass |
| following structure | | |
| Polymerization initiator | 3.00 | parts by mass |
| (IRGACURE (registered trade name) | | |
| 907, manufactured by BASF SE) | | |
| Photosensitizer (KAYACURE DETX-S, | 1.00 | part by mass |
| manufactured by Nippon Kayaku Co., Ltd.) | | |
| Leveling agent T-1 | 0.08 | parts by mass |
| Methyl ethyl ketone | 936.00 | parts by mass |

### Liquid Crystal Compound L-3

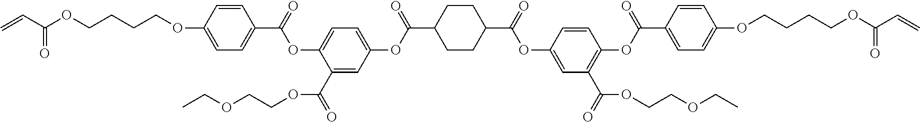 [SMILES: C=CC(=O)OCCCCOc1ccc(C(=O)Oc2ccc(OC(=O)C3CCC(C(=O)Oc4ccc(OC(=O)c5ccc(OCCCCOC(=O)C=C)cc5)c(C(=O)OCCOCC)c4)CC3)cc2C(=O)OCCOCC)cc1]

The composition C-1 was applied to the first optically-anisotropic layer, and was heated and cured using the same method as that of the second optically-anisotropic layer to form a third optically-anisotropic layer having a thickness of 0.05 μm. As a result, the optical element including the first to third optically-anisotropic layers was manufactured.

In a case where the birefringence Δn and the thickness T of each of the first to third optically-anisotropic layers was measured using the above-described method, the birefringence Δn1 was 0.25 and the thickness T1 was 2.65 μm in the first optically-anisotropic layer, the birefringence Δn2 was 0.15 and the thickness T2 was 0.05 μm in the second optically-anisotropic layer, and the birefringence Δn3 was 0.10 and the thickness T3 was 0.05 μm in the third optically-anisotropic layer. That is, Δn1>Δn2 and Δn1>Δn3 were satisfied, and T2/T1 was 0.019 and T3/T1 was 0.019, both of which satisfied 0.002 or more and 0.3 or less.

The liquid crystal compound L-1 used for forming the first optically-anisotropic layer was the tolane type liquid crystal compound.

### Examples 2 to 4 and Comparative Examples 1 and 2

Optical elements according to Examples 2 to 4 and Comparative Examples 1 and 2 in the periodic alignment state where the single period over which the optical axis of the liquid crystal compound rotated by 180° was 1.8 μm were formed using the same method as that of Example 1, except that the liquid crystal composition for forming each of the optically-anisotropic layers was changed as shown in Table 1 and the configuration of each of the optically-anisotropic layers was changed as shown in Table 2. Table 3 shows the formulation of the liquid crystal composition according to each of Examples and Comparative Examples.

TABLE 1

| | | | | | | | | Compar- | Compar- |
|---|---|---|---|---|---|---|---|---|---|
| | | | | | | | | ative | ative |
| | | | Example | Example | Example | Example | Example | Example | Example |
| | | | 1 | 2 | 3 | 4 | 5 | 1 | 2 |
| Second Optically- | | Kind of | A-1 | A-1 | A-1 | A-1 | A-1 | — | A-1 |
| Anisotropic Layer | | Composition | | | | | | | |
| First | First- | Kind of | B-1 | B-1 | B-4 | B-7 | B-4 | B-1 | B-1 |
| Optically- | X | Composition | | | | | | | |
| Anisotropic | First- | Kind of | B-2 | B-2 | B-5 | B-8 | B-5 | B-2 | B-2 |
| Layer | Y | Composition | | | | | | | |
| | First- | Kind of | B-3 | B-3 | B-6 | B-9 | B-6 | B-3 | B-3 |
| | Z | Composition | | | | | | | |
| | | Kind of | Tolane | Tolane | Thiotolane | Tolane | Thiotolane | Non-Tolane | Tolane |
| | | Liquid | Type | Type | Type | Type | eType | Type | Type |
| | | Crystal | | | | | | | |

| | | | | | | | | |
|---|---|---|---|---|---|---|---|---|
| Third Optically- | Kind of | C-1 | — | C-1 | C-1 | C-1 | — | — |
| Anisotropic Layer | Composition | | | | | | | |

TABLE 2

| | | | | | | | | Compar- | Compar- |
|---|---|---|---|---|---|---|---|---|---|
| | | | | | | | | ative | ative |
| | | | Example | Example | Example | Example | Example | Example | Example |
| | | | 1 | 2 | 3 | 4 | 5 | 1 | 2 |
| Liquid Crystal Alignment Pattern | | | Fixed | Fixed | Fixed | Fixed | Radial | Fixed | Fixed |
| Second | Birefringence Δn2 | | 0.15 | 0.15 | 0.15 | 0.15 | 0.15 | | 0.15 |
| Optically- | Thickness T2 [μm] | | 0.05 | 0.05 | 0.05 | 0.05 | 0.05 | | 0.9 |
| Anisotropic | | | | | | | | | |
| Layer | | | | | | | | | |
| First | Birefringence Δn1 | | 0.25 | 0.25 | 0.31 | 0.20 | 0.31 | 0.25 | 0.25 |
| Optically- | Thickness T1 [μm] | | 2.65 | 2.67 | 2.14 | 3.31 | 2.14 | 2.70 | 2.16 |
| Anisotropic | First-X | Re(550) [nm] | 160 | 160 | 160 | 160 | 160 | 160 | 160 |
| Layer | | Twisted | −80° | −80° | −80° | −80° | −80° | −80° | −80° |
| | | Angle | | | | | | | |
| | First-Y | Re(550) [nm] | 342 | 347 | 342 | 342 | 342 | 355 | 220 |
| | | Twisted | +4º | +4° | +4° | +4° | +4° | +4° | +4° |
| | | Angle | | | | | | | |
| | First-Z | Re(550) [nm] | 160 | 160 | 160 | 160 | 160 | 160 | 160 |
| | | Twisted | +80° | +80° | +80° | +80° | +80° | +80° | +80° |
| | | Angle | | | | | | | |

| | | | | | | | | |
|---|---|---|---|---|---|---|---|---|
| Third | Birefringence Δn3 | 0.10 | | 0.10 | 0.10 | 0.10 | | |
| Optically- | Thickness T3 [μm] | 0.05 | | 0.05 | 0.05 | 0.05 | | |
| Anisotropic | | | | | | | | |
| Layer | | | | | | | | |
| Total | Re(550) [nm] | 675 | 675 | 675 | 675 | 675 | 675 | 675 |

| | | | | | | |
|---|---|---|---|---|---|---|
| Thickness Ratio: T2/T1 | 0.019 | 0.019 | 0.023 | 0.015 | 0.023 | 0.417 |
| Thickness Ratio: T3/T1 | 0.019 | | 0.023 | 0.015 | 0.023 | |

TABLE 3

| | | Liquid Crystal Composition | | | | | | | | | | |
|---|---|---|---|---|---|---|---|---|---|---|---|---|
| | | A-1 | B-1 | B-2 | B-3 | B-4 | B-5 | B-6 | B-7 | B-8 | B-9 | C-1 |
| Liquid Crystal | L-1 | 100 | | | | | | | 50 | 50 | 50 | |
| Compound | L-2 | | 100 | 100 | 100 | | | | 50 | 50 | 50 | |
| | L-3 | | | | | | | | | | | 100 |
| | L-4 | | | | | 100 | 100 | 100 | | | | |
| Chiral Agent | A | 0.11 | | | | | | | | | | 0.11 |
| | C-3 | | 0.23 | 0.54 | 0.48 | 0.23 | 0.54 | 0.48 | 0.23 | 0.54 | 0.48 | |
| | C-4 | | 0.82 | 0.62 | | 0.82 | 0.62 | | 0.82 | 0.62 | | |
| Polymerization | Irg907 | 3 | | | | | | | | | | 3 |
| Initiator | 0XE01 | | 1 | 1 | 1 | 1 | 1 | 1 | 1 | 1 | 1 | |
| Photosensitizer | DETX-S | 1 | | | | | | | | | | 1 |
| Leveling Agent | T-1 | 0.08 | 0.08 | 0.08 | 0.08 | 0.08 | 0.08 | 0.08 | 0.08 | 0.08 | 0.08 | 0.08 |
| Solvent | MEK | 936 | 1050 | 1050 | 1050 | 1050 | 1050 | 1050 | 1050 | 1050 | 1050 | 936 |

### Liquid Crystal Compound L-4

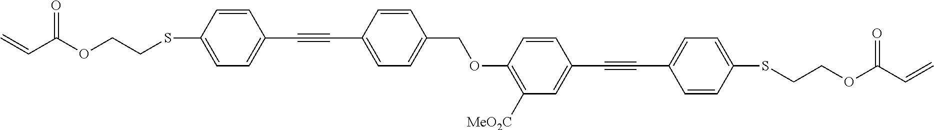 [SMILES: C=CC(=O)OCCSc1ccc(C#Cc2ccc(COc3ccc(C#Cc4ccc(SCCOC(=O)C=C)cc4)cc3C(=O)OC)cc2)cc1]

### Example 5

Each of the optically-anisotropic layers was formed using the above-described method, except that the alignment film was exposed using the exposure device shown in FIG. 10, such that the arrangement axis of the liquid crystal alignment pattern was radial and the single period of the liquid crystal alignment pattern gradually decreased toward the outer direction, the liquid crystal composition for forming each of the optically-anisotropic layers was changed as shown in Table 1, and the configuration of each of the optically-anisotropic layers was changed as shown in Table 2. As a result, an optical element having a concentric pattern where the single period of a portion at a distance of about 2 mm from the center was 10 μm and the single period of a portion at a distance of 15 mm from the center was 1.8 μm was formed.

### Evaluation

### <Measurement of Intensity of Light>

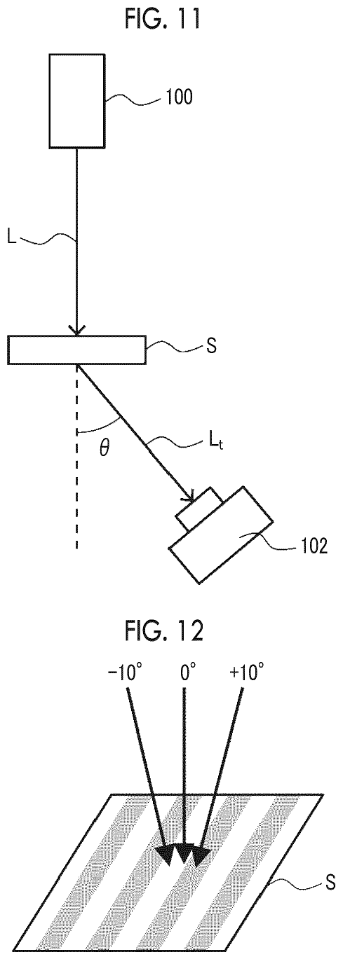

Using a method shown in FIG. 11, a relative intensity of light was measured.

In a case where light was incident into the manufactured optical element from each of the front (direction with an angle of 0° with respect to the normal line), a direction with an angle of 10° with respect to the normal line, and a direction with an angle of −10° with respect to the normal line as shown in FIG. 12, a relative intensity of transmitted light with respect to the incidence light was measured. The angle of 10° or −10° with respect to the normal line was tilted in the direction in which the optical axis of the liquid crystal compound rotated, that is, the direction along the arrangement axis.

Specifically, laser light L having an output central wavelength of 530 nm was caused to be vertically incident from a light source 100 into the glass surface side of the manufactured optical element S. The transmitted light was captured using a screen disposed at a distance of 100 cm to calculate a transmission angle θ for the primary diffracted light. Next, the intensity of transmitted light Lt transmitted at a transmission angle θ was measured using a photodetector 102. A ratio of the intensity of the transmitted light Lt and the intensity of the light L was calculated. The measurement was performed at three points with light incidence angles of −10°, 0°, and +10° to calculate the average value at the three points as the diffraction efficiency. Laser light was caused to be vertically incident into the circularly polarizing plate corresponding to the wavelength of the laser light to be converted into circularly polarized light, the circularly polarized light was incident into the manufactured optical element, and the evaluation was performed. In addition, in Example 5 including the concentric pattern, the diffraction efficiency at a position of 15 mm from the center of the concentric circle was measured.

The results are shown in Table 4.

TABLE 4

| | | | | | | | Compar- | Compar- |
|---|---|---|---|---|---|---|---|---|
| | | | | | | | ative | ative |
| | | Example | Example | Example | Example | Example | Example | Example |
| | | 1 | 2 | 3 | 4 | 5 | 1 | 2 |
| Evaluation | Diffraction | 90% | 89% | 91% | 89% | 91% | 87% | 86% |
| | Efficiency | | | | | | | |

It can be seen from Table that, in Examples to according to the present invention, a higher diffraction efficiency can be obtained as compared to Comparative Examples.

In addition, it can be seen that, in Comparative Example 1, since the second and third optically-anisotropic layers having the low birefringence were not provided on the surface side, the reflection from the surface increases such that the diffraction efficiency decreases. In addition, it can be seen that, in Comparative Example 2, since the thicknesses of the second and third optically-anisotropic layers having the low birefringence are large, the diffraction efficiency is low as a whole.

In addition, it can be seen from a comparison between Examples 1 and 2 that the optically-anisotropic layer having the low birefringence is preferably provided on both surfaces.

In addition, it can be seen from a comparison between Examples 1 and 3 that the thiotolane type liquid crystal compound is preferably used as the liquid crystal compound.

In addition, it can be seen from a comparison between Examples 1 and 4 that the birefringence Δn1 of the first optically-anisotropic layer is preferably 0.21 or higher.

As can be seen from the above results, the effects of the present invention are obvious.

### EXPLANATION OF REFERENCES

10, 10b: optical element
12, 12b, 12c, 12d: first optically-anisotropic layer
13, 13c: second optically-anisotropic layer
14, 14c: third optically-anisotropic layer
30: support
32: alignment film
37a, 37b, 37c: region
40: liquid crystal compound
40A: optical axis
42: bright portion
44: dark portion
60, 80: exposure device
62, 82: laser
64, 84: light source
65: λ/2 plate
68: beam splitter
70A, 70B, 90A, 90B: mirror
72A, 72B: λ/4 plate
86, 94: polarization beam splitter
92: lens
94: λ/4 plate
100: light source
102: photodetector
D, A₁, A₂, A₃: arrangement axis
R: region
Λ: single period
L₁, L₂: incidence light
L₄, L₅: emitted light
M: laser light
MA, MB: beam
P₀: linearly polarized light
P_{R}: right circularly polarized light
P_{L}: left circularly polarized light
α: intersecting angle
MS: S polarized light
MP: P polarized light

What is claimed is:

1. An optical element comprising at least:
a first optically-anisotropic layer that is formed of a liquid crystal composition including a liquid crystal compound; and
a second optically-anisotropic layer that is formed of a liquid crystal composition including a liquid crystal compound,
wherein the first optically-anisotropic layer and the second optically-anisotropic layer have a liquid crystal alignment pattern in which an orientation of an optical axis derived from the liquid crystal compound changes while continuously rotating in at least one in-plane direction,
a birefringence Δn1 of the first optically-anisotropic layer and a birefringence Δn2 of the second optically-anisotropic layer satisfy a relationship of Expression (1),
a thickness T1 of the first optically-anisotropic layer and a thickness T2 of the second optically-anisotropic layer satisfy a relationship of Expression (2), and
transmitted light is diffracted,
$$Δ n 1 > Δ n 2 , and \qquad Expression ( 1 )$$
$$0.002 \leq T 2 / T 1 \leq 0.3 . \qquad Expression ( 2 )$$

2. The optical element according to claim 1,
wherein the birefringence Δn1 is 0.21 or more and 0.50 or less, and
the birefringence Δn2 is 0.05 or more and 0.20 or less.

3. The optical element according to claim 1, further comprising:
a third optically-anisotropic layer that is formed of a liquid crystal composition including a liquid crystal compound,
wherein the third optically-anisotropic layer has a liquid crystal alignment pattern in which an orientation of an optical axis derived from the liquid crystal compound changes while continuously rotating in at least one in-plane direction,
the second optically-anisotropic layer, the first optically-anisotropic layer, and the third optically-anisotropic layer are laminated in this order,
a birefringence Δn3 of the third optically-anisotropic layer and the birefringence Δn1 satisfy a relationship of Expression (3), and
a thickness T3 of the third optically-anisotropic layer and the thickness T1 satisfy a relationship of Expression (4),
$$Δ n 1 > Δ n 3 , and \qquad Expression ( 3 )$$
$$0.002 \leq T 3 / T 1 \leq 0.3 . \qquad Expression ( 4 )$$

4. The optical element according to claim 3,
wherein the birefringence Δn3 is 0.05 or more and 0.20 or less.

5. The optical element according to claim 3,
wherein the birefringence Δn1, the birefringence Δn2, and the birefringence Δn3 satisfy relationships of Expressions (5) and (6),
$$0.1 \leq Δ n 1 - Δ n 2 \leq 0.25 , and \qquad Expression ( 5 )$$
$$0.1 \leq Δ n 1 - Δ n 3 \leq 0.25 . \qquad Expression ( 6 )$$

6. The optical element according to claim 1,
wherein the thickness T1 is 1 μm to 3 μm.

7. The optical element according to claim 1,
wherein the liquid crystal compound is a tolane type liquid crystal compound.

8. The optical element according to claim 1,
wherein the liquid crystal compound is a thiotolane type liquid crystal compound.

9. The optical element according to claim 1,
wherein the first optically-anisotropic layer has a region where the optical axis of the liquid crystal compound is twisted along a thickness direction in a plane, and
a twisted angle of the region in the thickness direction is 100 to 360°.

10. The optical element according to claim 3,
wherein in the liquid crystal alignment pattern of the first to third optically-anisotropic layers, the one direction in which the orientation of the optical axis derived from the liquid crystal compound changes while continuously rotating is provided in a radial shape from an inner side toward an outer side.

11. An image display apparatus comprising:
the optical element according to claim 1.

12. The image display apparatus according to claim 11, which is a head mounted display.

13. The optical element according to claim 2, further comprising:
a third optically-anisotropic layer that is formed of a liquid crystal composition including a liquid crystal compound,
wherein the third optically-anisotropic layer has a liquid crystal alignment pattern in which an orientation of an optical axis derived from the liquid crystal compound changes while continuously rotating in at least one in-plane direction,
the second optically-anisotropic layer, the first optically-anisotropic layer, and the third optically-anisotropic layer are laminated in this order,
a birefringence Δn3 of the third optically-anisotropic layer and the birefringence Δn1 satisfy a relationship of Expression (3), and
a thickness T3 of the third optically-anisotropic layer and the thickness T1 satisfy a relationship of Expression (4),
$$Δ n 1 > Δ n 3 , and \qquad Expression ( 3 )$$
$$0.002 \leq T 3 / T 1 \leq 0.3 . \qquad Expression ( 4 )$$

14. The optical element according to claim 13,
wherein the birefringence Δn3 is 0.05 or more and 0.20 or less.

15. The optical element according to claim 4,
wherein the birefringence Δn1, the birefringence Δn2, and the birefringence Δn3 satisfy relationships of Expressions (5) and (6),
$$0.1 \leq Δ n 1 - Δ n 2 \leq 0.25 , and \qquad Expression ( 5 )$$
$$0.1 \leq Δ n 1 - Δ n 3 \leq 0.25 . \qquad Expression ( 6 )$$

16. The optical element according to claim 2,
wherein the thickness T1 is 1 μm to 3 μm.

17. The optical element according to claim 2,
wherein the liquid crystal compound is a tolane type liquid crystal compound.

18. The optical element according to claim 2,
wherein the liquid crystal compound is a thiotolane type liquid crystal compound.

19. The optical element according to claim 2,
wherein the first optically-anisotropic layer has a region where the optical axis of the liquid crystal compound is twisted along a thickness direction in a plane, and
a twisted angle of the region in the thickness direction is 100 to 360°.

20. The optical element according to claim 4,
wherein in the liquid crystal alignment pattern of the first to third optically-anisotropic layers, the one direction in which the orientation of the optical axis derived from the liquid crystal compound changes while continuously rotating is provided in a radial shape from an inner side toward an outer side.
